(19) United States
(12) Patent Application Publication
(10) Pub. No.: US 2026/0246634 A1
(43) Pub. Date: Aug. 20, 2026

(54) Audit_Resilient BEI _24HWS Human Sovereign Soft_Core Chip Ecosystem

(71) Applicant: FURONG BEI, SAN GABRIEL, CA (US)

(72) Inventor: FURONG BEI, SAN GABRIEL, CA (US)

(21) Appl. No.: 19/193,369

(22) Filed: Apr. 29, 2025

(51) Int. Cl. H04L 9/32; H04L 9/00

(52) U.S. Cl. CPC H04L 9/32; H04L 9/50

(57) ABSTRACT

An audit-resilient BEI×24HWS soft-hard core chip ecosystem converts domain-routed identity, behavior, service, resource, and time records into verified economic records. A Behavioral Capture Layer generates signed behavior-event envelopes; a ReadName identity vault binds envelopes to identity anchors; a domain substrate resolves signed endpoint records; proof and policy gates verify authenticity, authorization, time-window validity, anti-replay state, and policy compliance; and a TimeStamp-to-Token, TimeCoin, TimeFlux, BEMINT, or BEPU engine executes atomic mint-and-bind transitions. Generated BEI Currency, TimeCurrency, behavioral energy units, mint certificates, receipts, DomainYLD signals, and index records are signed, called back, cleared, settled, corrected, rolled back, and indexed. Hardware-assisted security may provide root-of-trust attestation, isolation domains, protocol agility, side-channel masking, honeypot endpoints, anomaly detection, checkpoint rollback, and secure event logging, enabling transaction-ready licensing, asset packaging, auditability, and cross-industry deployment.

### CROSS-REFERENCE TO RELATED APPLICATIONS

This application is related to U.S. patent application Ser. No. 19/193,369, filed Apr. 29, 2025, titled Audit-Resilient BEI×24HWS Human Sovereign Soft-Core Chip Ecosystem, and to related BEI, ATMS, BEIMINT, BEIGX, BEISX, BEIINDEX, TimeCurrency, domain-namespace, rooted-domain, BEISign, AutoVerify receipt, BEIFR2 rollback, clearing, settlement, identity, domain-node, and security applications identified in an Application Data Sheet or other accepted filing record.

Any domestic benefit, continuation, continuation-in-part, divisional, priority, or other continuity relationship is claimed only to the extent properly set forth in the official Application Data Sheet or other accepted USPTO filing record. Applications not expressly listed in the Application Data Sheet may be treated as related, companion, implementation, or background applications, without relying on them for priority.

The present disclosure technically organizes subject matter concerning software-defined behavioral-economic chips, hardware-assisted secure modules, domain-name routing, signed endpoint records, Behavioral Economics Identity, behavior-event evidence, life-time event records, policy-gated minting, TimeCurrency, BEI Currency, clearinghouse settlement, rollback or clawback records, index computation, and asset-package deployment.

### TECHNICAL FIELD

The disclosure relates to distributed computing systems, software-defined chips, hardware-assisted secure modules, secure elements, trusted execution environments, domain-name routing systems, digital identity systems, cryptographic proof verification, behavior-based record generation, time-denominated value systems, automated verification receipts, policy-controlled minting, tamper-evident audit trails, clearinghouse settlement, index computation, and standardized interfaces for converting identity-anchored behavior and time-windowed life events into verifiable economic records.

More particularly, the disclosure relates to a BEI behavioral-economic logic soft-hard core chip system in which domain names, subdomains, rooted domains, identity anchors, behavior objects, life-time events, proof bundles, policy containers, minting rules, receipts, clearing records, rollback records, and index signals are processed as a unified behavior-economic computation fabric.

### BACKGROUND OF THE INVENTION

Conventional Internet systems generally treat a domain name as an address used to route a browser to a website. Such systems do not, by themselves, establish a domain or subdomain as a programmable resource basepoint bound to an identity anchor, proof endpoint, policy bundle, minting rule, wallet endpoint, callback endpoint, clearing route, audit endpoint, and index module.

Conventional identity systems generally treat a user as an account, login, credential, or KYC profile. Such systems authenticate access but generally do not transform a person, family, organization, industry, region, nation, device, or domain node into an identity-anchored behavior-economic endpoint that can generate signed records, time-denominated value, clearing receipts, and index signals.

Conventional silicon chips, GPU accelerators, secure elements, and data-center processors are powerful for electronic-signal processing, graphics computation, cryptographic computation, and neural-network computation. They do not, by themselves, define a system in which a human action, service event, domain node, time contribution, and identity relationship become a signed, recoverable, clearable, and indexable economic record.

Proof-of-work mining systems may consume substantial electrical power and specialized hardware to create digital tokens. Many reward systems create points or credits, but they do not combine a domain-rooted identity infrastructure, automatic service receipts, privacy-preserving verification, anti-replay controls, rollback and clawback audit chains, behavior-to-TimeCurrency conversion, clearing registration, and index computation in a unified chip-level logic architecture.

Existing financial, Web3, payment, e-signature, customer relationship management, healthcare, Internet-of-Things, education, asset, and government systems solve partial problems. They do not reorganize domain names, identities, service records, behavior, time, assets, receipts, clearing records, policy containers, and index values as a single behavior-economic logic system capable of execution by software-defined and hardware-assisted chip architecture.

Accordingly, a need exists for a concrete technical system that converts a domain name from a mere web address into a rooted economic node, converts identity from a login profile into a behavior-economic entity, converts a receipt from a payment proof into a behavior proof, converts time from consumption into verifiable value, and converts records into clearable and indexable economic units.

### SUMMARY OF THE INVENTION

The present disclosure provides an audit-resilient BEI×24HWS human sovereign soft-hard core chip ecosystem for domain-routed behavior-to-currency and TimeCurrency generation. The system may be implemented as software executed on cloud servers, mobile devices, web applications, wallet systems, WordPress multisite deployments, WooCommerce workflows, or distributed nodes; as a hardware-assisted secure module using a trusted execution environment, secure element, SIM or eSIM, NFC device, IoT sensor, wearable terminal, point-of-sale terminal, identity terminal, hardware wallet, or gateway; or as a semiconductor-implementable behavioral economic processing unit.

In one aspect, the system includes a behavior input layer, a BEI identity anchor layer, a domain loading and routing substrate, a signed endpoint record layer, a proof gate and policy gate layer, a BEI logic code engine, a BEMINT core or behavioral economic processing unit, a signature and receipt layer, a callback and audit layer, a rollback or clawback module, a clearing and settlement module, and an index feedback layer.

The BEI chip executes foundational logic by which domain names are treated as economic roots, identities are treated as behavior-economic entities, receipts are treated as behavior proof, time is treated as a value source, trust is generated through automatic verification and signature chains, corrections are generated as rollback or clawback records rather than hidden deletions, assets are represented as multidimensional nodes, and indices are extended from market-price indices into behavioral-economic indices.

The system can support a chain comprising domain loading, domain value assignment, rooted-domain registration, identity anchoring, behavior or service or life-time event recording, automatic receipt generation, signature application, callback synchronization, audit and recovery, time-based value processing, minting, clearing registration, settlement, reconciliation, and index computation.

The system is productizable as BEI AutoVerify Receipt, Rooted Domain Certificate, DomainYLD report, BEI-ID profile, BEISign record, BEICallback service, recoverable BEI record, TimeCurrency receipt, BEI Currency receipt, BIGX genesis record, BEIGX or BEISX clearing record, and BIGindex or BEIINDEX score. Each product module may be mapped to patent-protective groups, service workflows, revenue models, receipt records, licensing fields, and index outputs.

### BRIEF DESCRIPTION OF THE DRAWINGS

FIG. 1 illustrates a comparison between a conventional silicon chip and a BEI soft-core or soft-hard behavioral-economic chip.

FIG. 2 illustrates an energy conversion model in which behavior capture is time-stamped, processed by a TimeCoin or BEMINT engine, bound to a sovereign identity vault, and fed back through resource allocation.

FIG. 3 illustrates an overall module structure including a behavioral capture layer, TimeCoin or TimeCurrency minting layer, ReadName or BEI sovereign identity vault, ecosystem smart-contract layer, and decentralized evolution module.

FIG. 4 illustrates global node deployment in which personal nodes connect to local industry subnets, global mainnet nodes, and remote relay or gateway nodes.

FIG. 5 illustrates a Behavioral Economics Identity domain-name network system structure including a hierarchical domain-namespace topology, signed endpoint records, policy-controlled minting, receipt generation, clearing, settlement, audit, compliance, and index flow.

FIG. 6 illustrates a BEI Auto Verify receipt generation and verification flow.

FIG. 7 illustrates BEISign, BEICallback, rollback, and clawback record chaining.

FIG. 8 illustrates a domain loading substrate and policy-container fabric.

FIG. 9 illustrates BEMINT core or BEPU behavior-to-currency and TimeCurrency generation.

FIG. 10 illustrates BIGX or BEIGX clearing and BIGindex or BEIINDEX computation.

FIG. 11 illustrates a hardware-assisted fractal defense and secure BEPU execution layer including PUF root-of-trust, isolation domains, protocol agility, side-channel masking, honeypot endpoints, anomaly detection, quarantine, checkpoint rollback, and immutable security-event logging.

FIG. 12 illustrates product-to-patent-to-service-to-receipt-to-index licensing mapping including foundational logic, product modules, patent-protective groups, service workflows, receipt evidence, index outputs, governance endpoints, field-of-use licensing, and semiconductor BEPU implementations.

### DETAILED DESCRIPTION OF THE INVENTION

### 1. Foundational BEI Logic Framework

In certain embodiments, BEI or ATMS is a domain-rooted behavioral-economic identity infrastructure executed by a soft-hard behavioral-economic logic chip. Domain names, identities, behavior records, service records, time events, resource records, and asset records are converted into verified, signed, recoverable, indexable, and clearable economic records.

A conventional Internet path may be described as domain to website to content to traffic. In contrast, the disclosed BEI logic path may be described as domain to identity to behavior to receipt to time value to asset to clearing to index. The logic is executed through concrete data objects, identity anchors, domain endpoint records, proof gates, policy containers, minting transitions, receipt ledgers, callback messages, rollback records, clearing records, and index signals.

The soft-hard core chip does not require that every function be executed on a semiconductor die. The chip may be a software-defined architecture, a hardware-assisted secure architecture, a distributed node architecture, or a semiconductor-implementable architecture in which instruction fields, registers, endpoints, proofs, policies, receipts, callbacks, rollback states, clearing messages, and index outputs are treated as behavioral-economic logic elements.

### 2. Definitions

BEI means Behavioral Economics Identity or behavior-economic identity, including identity data combined with behavior, time, services, assets, domain nodes, proof records, receipts, and index signals.

24HWS means a twenty-four-hour world service or time-windowed service framework in which hour, day, week, month, year, life-time, and generation-level windows can operate as temporal basepoints for minting, routing, clearing, and indexing.

ATMS means a digital identity, financial, banking, asset, time, and management center that may host or interoperate with BEI identity and value records.

BEI Logic Code means a machine-readable instruction string or state vector representing identity state, behavior class, time-window validity, proof grade, policy authorization, mint eligibility, clearing status, index status, and risk status.

Rooted Domain means a domain, subdomain, rooted-domain record, YueName, namespace identifier, URI, DID, ledger address, or other resolvable identifier registered as a verifiable, attributable, serviceable, measurable, and indexable digital parcel or economic node.

Signed Endpoint Record means a signed mapping that resolves a basepoint or domain node to service endpoints and associated protocol roles, including identity, proof, policy, minting, wallet, receipt, callback, clearing, exchange, governance, audit, and index roles.

Behavior Object means a structured data object representing an activity, including behavior type, timestamp, proof source, evidence commitment, service context, policy version, identity anchor, domain node, and optional privacy-safe display field.

Life-Time Event means a time-indexed behavioral activity occurring within a person, family, organization, service, domain node, or asset life cycle, including work, learning, health, care, service, invention, transaction, environmental contribution, or domain registration.

Policy Container means a signed, versioned, and time-bounded rule container associated with a domain, subdomain, identity, product module, jurisdiction, industry, service category, or time window.

Proof Gate means a validation mechanism that determines authenticity, uniqueness, authorization, time-window validity, anti-replay compliance, proof-source status, and risk status.

BEMINT Core or BEPU means a minting engine or behavioral economic processing unit that converts verified behavior and time events into BEI Currency, TimeCurrency, behavioral energy units, mint certificates, settlement receipts, or index signals.

BEIFR means a foundational record containing original facts of a service, identity, domain, behavior, asset, or time event. BEISign means a signature layer that signs or hashes a BEI foundational record and associates the record with a signer, provider, timestamp, verification link, and audit marker.

BEICallback means an automated callback layer that transmits record completion, service state, wallet state, clearing state, index state, or correction state to authorized endpoints. Rollback or clawback record means a correction or reversal record that references an original record without hiding or deleting the original record.

### 3. Material-Cell-Structure-System-Standard Framework

In certain embodiments, the BEI chip is organized into a material layer, a cell layer, a structural layer, a system layer, and a standard layer. The material layer includes domain-based substrates, subdomain nodes, rooted domains, identity anchors, time units, behavior objects, service objects, resource objects, currency objects, proof signals, evidence commitments, and policy containers.

The cell layer generates one or more domain cells, identity cells, behavior cells, proof cells, time cells, mint cells, receipt cells, clearing cells, audit cells, or index cells. The cell may be stored as a database object, ledger object, smart-contract state, secure-element state, or message envelope.

The structural layer arranges cells into a multi-system, multi-honeycomb, domain-rooted network including a domain grid, subdomain mesh, hierarchical routing tree, many-to-many mapping graph, or policy-container fabric. The system layer executes identity anchoring, proof gating, policy gating, minting, signing, callback, rollback, clearing, settlement, reconciliation, and indexing.

The standard layer defines BEI-ID formats, domain logic value formats, rooted-domain certificate formats, AutoVerify receipt formats, BEISign signatures, BEICallback messages, rollback records, TimeCurrency receipts, BIGX genesis records, and BIGindex scores. Such standards may be used internally, licensed externally, or published as integration schemas.

### 4. Core Modules

A domain loading and value module loads a domain name, subdomain, rooted domain, YueName, namespace identifier, URI, DID, or ledger address as a functional chip slot, routing node, policy-container node, receipt endpoint, wallet endpoint, clearing endpoint, or index endpoint.

An identity anchor module binds a person, family, organization, industry, region, nation, institutional entity, device, or domain node to a BEI identity anchor including a BEI-ID, DID, wallet address, account identifier, credential identifier, domain basepoint, or cryptographic key pair.

A behavior and life-time event module receives behavior objects, service objects, life-time events, work events, health events, care events, learning events, environmental events, transactions, inventions, resource interactions, and other actions as structured inputs.

A proof gate and policy gate module verifies authenticity, uniqueness, authorization, time-window validity, proof-source validity, jurisdictional compliance, industry rules, mint caps, rate limits, replay state, and anti-duplication conditions.

A BEI logic code engine executes machine-readable behavioral-economic logic codes representing identity state, behavior class, time window, proof grade, policy state, mint eligibility, clearing state, index state, and risk state.

A BEMINT core or behavioral economic processing unit converts verified behavior objects and time-windowed life events into BEI Currency, TimeCurrency, behavioral energy units, mint certificates, settlement receipts, Domain YLD signals, or index-ready records.

A BEISign signature module applies a cryptographic signature, hash, signer identifier, provider identifier, timestamp signature, and audit marker to a foundational record. A BEICallback synchronization module transmits service-completion events, webhooks, receipt updates, node updates, wallet updates, clearing messages, and index-update messages to authorized endpoints.

A rollback or clawback audit module preserves original records while generating correction records, reversal records, reason codes, authorized actor records, rollback hashes, and final-state records. A clearing and index feedback module aggregates verified receipts, domain records, service records, token units, time-value records, authorization interests, and node states into clearing-ready, settlement-ready, or index-ready records.

| Module | Representative Technical Role |
|---|---|
| Domain loading and | Loads a basepoint as a routing, policy, wallet, |
| value module | receipt, clearing, or index node. |
| Identity anchor module | Binds a subject to a cryptographic identity |
| | anchor, DID, wallet, credential, or domain |
| | basepoint. |
| Proof and policy gate | Validates authenticity, authorization, anti- |
| module | replay state, proof source, policy version, and |
| | compliance. |
| BEMINT core or BEPU | Converts verified behavior and time events |
| | into value outputs, receipts, settlement |
| | records, or index signals. |
| Callback and rollback | Synchronizes state and preserves original |
| module | records while generating correction or |
| | reversal records. |
| Clearing and index | Registers, clears, settles, reconciles, scores, or |
| layer | indexes generated records. |

### 5. Domain-Name Network and Signed Endpoint Routing

In certain embodiments, each human-readable basepoint and sub-basepoint resolves to a signed endpoint record specifying one or more protocol roles, including identity verification, proof verification, policy retrieval, mint request, wallet routing, receipt generation, callback synchronization, exchange listing, clearinghouse settlement, audit, compliance, and index publication.

Endpoint records are integrity-protected using signature verification and optionally DNSSEC, DANE, TLS certificate binding, DID document binding, ledger anchoring, Merkle-tree anchoring, or equivalent cryptographic control mechanisms. Endpoint records may be versioned with effective time windows to prevent replay and stale routing.

A hierarchical routing scheme maps population-scale sub-basepoints into regional, sector, organizational, family, personal, and device nodes, enabling scalable service discovery analogous to hotspot association while maintaining cryptographic verifiability and policy-bounded access control.

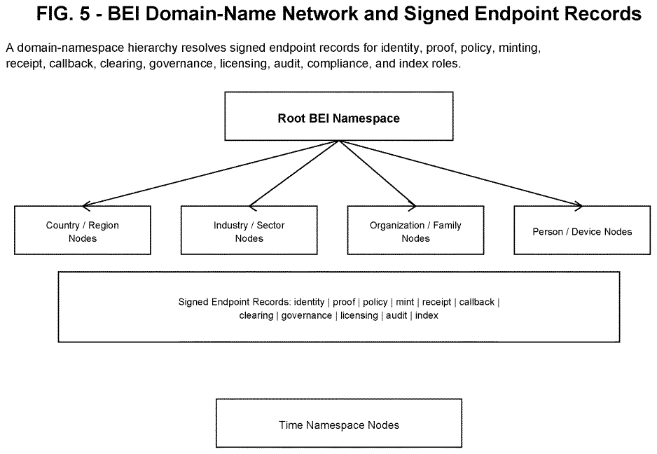

FIG. 5 illustrates a hierarchy comprising root BEI namespace or basepoints, country or region domain nodes, industry or sector domain nodes, organization or family domain nodes, person or device subdomain nodes, and time namespace nodes, all publishing or resolving signed endpoint records for identity, proof, policy, mint, receipt, clearing, audit, compliance, or index roles.

The value-flow path routes client applications or user devices through BEI registration and identity anchoring, a domain router or resolver, endpoint record verification, policy bundle or governance controls, proof verification, a BEMINT or minting factory, BEI Currency or TimeCurrency receipt generation, clearinghouse or exchange settlement, and audit, compliance, or index modules.

### 6. Behavior-Event Envelopes and Life-Time Event Objects

A signed behavior-event envelope may include an event identifier, identity anchor, source identifier, digital signature, event class, time reference, time-window identifier, evidence commitment, privacy metadata, policy-version identifier, domain node, device or terminal identifier, nonce, counter, and replay-prevention state.

A life-time event may include work, learning, health, care, service, daily living, invention, transaction, environmental contribution, domain registration, asset transfer, professional service, family service, institutional service, or other economically relevant action.

The system may store detailed data off-chain or in controlled databases while anchoring commitments to tamper-evident structures. The system may use zero-knowledge proof references, verifiable credential references, trusted-execution attestations, multi-signature attestations, threshold signatures, append-only logs, distributed ledgers, permissioned ledgers, WORM storage, or Merkle structures to establish provenance without unnecessary public disclosure of sensitive data.

### 7. Time-of Time Logic and TimeCurrency Generation

Time is processed as a nested, domain-routed temporal basepoint rather than a mere timestamp. Non-limiting time windows include second, minute, hour, day, week, month, year, service period, life period, generation-level period, professional service session, care period, education period, health period, environmental contribution period, or nested time window.

A TimeCurrency unit may be generated when a verified life-time event is associated with a time unit, proof source, policy container, provider identity, receiver identity, domain node, and value rule. The system may produce a verified time receipt that is stored, signed, called back to authorized endpoints, cleared, indexed, or represented as a mint certificate.

Time basepoints such as hour, day, week, month, year, life-time, and generation-level namespace identifiers may route different mint caps, replay-prevention states, audit cycles, settlement cycles, and index publication periods. A time namespace may also define a validity window for policy bundles, endpoint records, signatures, receipt display, clearing status, or rollback boundaries.

### 8. Policy Containers, Proof Gates, and Right-Wrong Logic

A policy container may define authorized sources, eligible event categories, weighting coefficients, minting caps, rate limits, jurisdiction routing, privacy constraints, audit permissions, rollback boundaries, clearing requirements, effective time windows, or index publication rules.

Proof gates evaluate authenticity, source authorization, time-window compliance, replay-prevention status, proof-source reputation, jurisdictional compliance, industry classification, human-need classification, minting cap, risk status, and signed policy-container version before value generation.

The system may maintain right-wrong logic as a technical state machine. A record may be accepted, rejected, quarantined, downgraded, rate-limited, frozen, corrected, rolled back, clawed back, or routed for manual review according to proof and policy state. The decision is preserved as part of the audit trail rather than being hidden or silently overwritten.

### 9. AutoVerify Receipt Engine

In certain embodiments, a user does not need to manually perform verification, download an application, remember a password, or understand the underlying cryptographic protocol. A user may provide a phone number, email address, name, domain, service identifier, wallet address, or minimal identity input. The system automatically generates a BEI-ID, service receipt, timestamp, privacy code, verification hash, verify link, callback message, and recoverable record.

An AutoVerified receipt may include a receipt identifier, BEI identity identifier, service type, provider identifier, domain node, timestamp, status, privacy-safe display fields, verification hash, optional QR code, policy version, evidence commitment, and audit metadata. A public verification page may show that the record exists, has not been altered, and corresponds to a particular service flow, while masking or hashing sensitive personal contact data.

A verification hash may be computed from one or more of a BEI-ID, receipt ID, service type, timestamp, domain node, privacy code, provider identifier, policy version, evidence commitment, nonce, or source signature. When a verify link is accessed, the system may recompute or validate the hash and display a verified status if the stored data is consistent with the recomputed data.

### 10. BEIER, BEISign, BEICallback, and Rollback or Clawback

A BEIFR may be generated as a foundational record containing the original facts of a service, identity, domain, behavior, asset, or time event. A BEISign module may sign the BEIFR using a system key, provider key, domain key, wallet key, secure element, trusted execution environment, or other authorized signing key.

The BEISign output may include a signature hash, signer identifier, service provider identifier, timestamp signature, audit marker, and verification URL. The signature may prove that the record existed at a particular time, was associated with a particular service flow, and has not been silently modified.

The BEICallback module may transmit a service-completion event or record update to an identity account, service ledger, wallet, domain node, BIGX clearing record, BIGindex computation module, DomainYLD module, TimeCurrency module, partner system, or third-party application. The callback may be implemented as a webhook, API call, message queue event, ledger update, signed endpoint message, email, SMS, push notification, or other state synchronization message.

If a record contains an error, the system may avoid hidden deletion or overwriting. Instead, a rollback or clawback module may generate a correction record or reversal record referencing the original record. The correction record may include a reason code, authorized actor, timestamp, rollback hash, original record identifier, replacement data, settlement impact, and final status. The audit chain may show the original state, correction state, and final state.

### 11. BEI Logic Code and BEI Logic Power

A BEI Logic Code may be implemented as a fixed-length, variable-length, hierarchical, or object-based instruction string. Positions or fields in the code may represent identity state, behavior class, time-window state, proof grade, policy state, mint eligibility, clearing state, index state, risk state, and manual-review state.

The BEI chip may execute identity gates, behavior gates, time gates, proof gates, policy gates, mint gates, clearing gates, index gates, and risk gates. Each gate may transform or validate a state and may generate a code update, receipt state, callback message, rollback record, clearing record, settlement message, or index output.

BEI Logic Power may be measured or represented by the capacity of the chip to process behavior objects and time-windowed events into value outputs. Metrics may include records processed per period, verified service events per period, time-value units generated, receipts signed, callbacks delivered, rollback events resolved, clearing records produced, index updates computed, or policy containers executed.

In contrast to a CPU that primarily executes electronic logic or a GPU or NPU that primarily accelerates mathematical or neural-network operations, a BEPU executes behavioral-economic logic over identity, time, behavior, proof, policy, minting, clearing, and index states.

| Logic-code field | Example state represented |
|---|---|
| Identity state | Anchored, unanchored, pending, revoked, |
| | delegated |
| Behavior class | Service, work, learning, care, transaction, |
| | invention, environmental contribution |
| Time-window state | Current, expired, future, nested, disputed |
| Proof grade | Self-attested, provider-attested, device- |
| | attested, multi-signature, zero-knowledge |
| Policy state | Authorized, capped, rate-limited, quarantined, |
| | frozen |
| Mint, clearing, and | Eligible, generated, pending clearing, settled, |
| index state | indexed, rolled back |

### 12. BEMINT Core or Behavioral Economic Processing Unit

The BEMINT core may receive a verified behavior object, BEI identity anchor, time window, proof bundle, policy container, domain node, and service state. The core may compute a behavior weight, time weight, identity weight, policy coefficient, risk coefficient, domain coefficient, and index coefficient. The core may then generate a mint certificate, BEI Currency unit, TimeCurrency unit, behavioral energy unit, DomainYLD signal, service value signal, or index-ready record.

The system may perform low-energy behavior-to-value processing. Unlike proof-of-work mining, the system does not require energy-intensive hash computation to generate value outputs. Instead, the system activates and converts verified human behavior, service time, domain node activity, resource interaction, and identity-linked events into structured economic records.

In certain embodiments, the system may be described as a behavior-energy conversion panel because it converts identity-anchored behavior and life-time events into BEI Currency, TimeCurrency, receipts, clearing outputs, and index signals. Such description identifies the conversion function and is not limited to any particular physical energy source.

### 13. BIGX Clearing, BEIGX or BEISX Settlement, and BIGindex Feedback

A BIGX clearing module may register BEI identities, rooted domains, domain certificates, Auto Verified receipts, BEISign records, TimeCurrency records, BEI Currency records, authorization rights, service rights, and asset records. The clearing module may be implemented as a registration and clearing system before or without operating as a securities exchange.

A BIGX genesis record may include a record identifier, BEI identity, domain node, product module, asset type, value source, receipt references, policy profile, clearing status, settlement route, index status, and verification hash. Such a record may support internal accounting, service history, licensing, transfer readiness, audit, due diligence, or external verification.

A BIGindex or BEIINDEX module may compute one or more scores for persons, families, companies, industries, countries, regions, domains, services, time values, patents, trademarks, companies, data assets, environmental contributions, healthcare services, educational services, and other BEI records. The index may be used for reporting, ranking, research, subscription data, due diligence, valuation support, or governance feedback.

Index values may feed back into policy containers, mint limits, service tiers, domain yield reports, Rooted Domain Certificates, BEI identity profiles, ATMS dashboards, or exchange-readiness records. The system thereby creates a loop: behavior to receipt to value to clearing to index to feedback to further behavior.

### 14. Multi-Entity, Multi-Industry, Multi-Currency, and Regulatory Interfaces

The system may support multiple entity types including individuals, families, organizations, enterprises, industries, regions, nations, governmental bodies, international institutions, and autonomous or semi-autonomous system actors. Each entity type may be represented as an identity node, domain node, policy-container node, wallet node, clearing node, settlement node, or index node.

The system may include a multi-dimensional taxonomy framework for human needs, industry classifications, resource categories, currency types, and regulatory domains. A human-need taxonomy may include 999 needs or another configurable number of needs. An industry taxonomy may include 365 industries or another configurable number of sectors. These numbers are examples and may be configured without limiting the invention.

A currency mapping layer may map BEI Currency, TimeCurrency, fiat currencies, stablecoins, CBDC references, internal credits, resource credits, service credits, and other value units. The system may provide reference conversion, simulated clearing, internal ledger conversion, clearinghouse messages, settlement receipts, or index-linked value conversion. The system need not perform regulated currency exchange unless properly authorized.

A regulatory profile layer may associate a domain, service, entity, jurisdiction, industry, product module, or time window with applicable policy constraints. Examples include KYC or AML profiles, health privacy constraints, legal service constraints, financial service constraints, consumer protection rules, data privacy rules, cross-border restrictions, audit duties, reporting rules, and rate limits.

### 15. Software, Hardware, and Semiconductor Implementations

The disclosed chip may be implemented as a software-defined chip executed by a website, application, server, cloud service, WordPress network, WooCommerce product workflow, BEI Node plugin, wallet, mobile app, API service, or distributed application. In such embodiments, software modules perform domain loading, identity generation, receipt generation, verification, signing, callback, rollback, minting, clearing, settlement, and indexing.

The chip may also be implemented as a hardware-assisted secure module. Hardware may include secure elements, trusted execution environments, SIM modules, eSIM modules, NFC devices, IoT sensors, wearable devices, mobile devices, point-of-sale terminals, identity cards, payment terminals, domain terminals, router devices, edge devices, or hardware wallets. Hardware may perform local signing, timestamping, key protection, offline receipt generation, anti-tamper validation, sensor attestation, or proof acceleration.

In future embodiments, the chip may be implemented as a semiconductor-implementable BEI behavioral economic processing unit. The BEPU may include instruction decoders for BEI Logic Codes, secure key storage, receipt hash accelerators, proof-gate accelerators, policy-container memory, minting transition logic, callback queues, rollback registers, clearing interfaces, and index-signal output logic.

A soft-hard interface layer may transmit BEI logic codes, signed behavior objects, policy-container parameters, proof requests, minting instructions, receipt objects, callback messages, rollback records, wallet updates, clearing outputs, settlement messages, and index-update messages between software and hardware layers.

### 16. Product Modules and Patent-Protective Groups

Foundational logic may be mapped to product modules, patent-protective groups, and economic value channels. Domain Logic Value may be implemented as Rooted Domain Certificates. BEI Identity Logic may be implemented as BEI-ID or BEI identity profiles. AutoVerify Logic may be implemented as BEI AutoVerify Receipts. BEISign Logic may be implemented as signed records. BEICallback Logic may be implemented as callback services. Rollback or clawback logic may be implemented as recoverable records. TimeCurrency logic may be implemented as verified time receipts. BIGX and BIGindex logic may be implemented as genesis records and index scores.

In certain embodiments, the system converts foundational logic into product modules, product modules into patent-protective systems, and patent-protective systems into verified services, receipts, records, indices, and revenue. A product module may be displayed on a website, offered as a service, included in a subscription, called through an API, licensed to a third party, or mapped to a patent-portfolio dashboard.

| | | Patent- | |
|---|---|---|---|
| | Product | protective | |
| Logic | module | group | Economic use |
| Domain Logic | Rooted | Domain | Certificate fees, |
| Value | Domain | node/rooted | reports, premium |
| | Certificate | domain | nodes, licensing |
| BEI identity | BEI-ID/BEI | Behavior- | Enterprise identity, |
| logic | profile | economic | family profiles, |
| | | identity | membership |
| Auto Verify | Auto Verified | Service | Per-receipt fee, |
| logic | receipt | receipt and | subscription, API fee |
| | | verification | |
| BEISign/Callback | Signed | Trust and | Contract proof, |
| | record/callback | workflow | compliance, SaaS |
| | service | automation | integration |
| Rollback logic | Recoverable | Correction | Compliance service, |
| | BEI record | and audit | audit service |
| TimeCurrency | TimeCurrency | Time | Professional time |
| logic | receipt | value and | reports and service |
| | | minting | markets |
| BIGX/Index | Genesis | Clearing | Index subscriptions, |
| logic | record/index | and | diligence reports, |
| | score | analytics | clearing service |

### 17. Keyword Asset B and Premium Node Control

The system may include a keyword asset registry that stores system keywords, BEI core keywords, domain category keywords, industry keywords, lifestyle keywords, medical keywords, financial keywords, legal keywords, geographic keywords, commerce keywords, and technology keywords. The registry may include a keyword, category, tier, status, root domain, price, reason, owner, policy profile, and notes.

Statuses may include blocked, reserved, premium, approval-only, and available. System keywords such as admin, api, login, verify, receipt, callback, rollback, beisign, bigx, bigindex, and wp-admin may be blocked. Core BEI keywords may be reserved. Premium industry terms may require payment or approval. Regulated terms may require manual review.

The keyword registry may transform a rejected or controlled registration into a sales, certification, application, or alternative-route path. For example, if a user requests a regulated medical node, the system may display that the node requires proof, approval, or a certificate, and may offer an alternative subdomain, Rooted Domain Certificate, or BEI identity certificate workflow.

### 18. Exemplary Operational Workflows

In a BEI Auto Verify Receipt workflow, a user enters a phone number, email address, name, wallet address, domain, or other minimal contact data. The system generates a BEI-ID, creates a service receipt, masks sensitive contact data, creates a privacy code, computes a verification hash, signs the record, sends a verify link by email or SMS, and optionally calls back to ATMS, BIGX, BIGindex, DomainYLD, or TimeCurrency modules.

In a Rooted Domain Certificate workflow, a domain owner or controller submits or selects a domain name. The system creates a domain loading record, checks keyword status and premium or approval-only rules, maps the domain to a category, industry, human-need taxonomy, jurisdiction, and identity anchor, generates a certificate, signs the certificate, creates a verify page, and optionally generates a DomainYLD report and BIGX genesis record.

In a TimeCurrency workflow, a provider performs a service for a receiver. The service duration is recorded as a time window. A proof source or provider confirmation is validated. A policy container determines whether the service is eligible for TimeCurrency. The BEMINT core generates a time receipt, TimeCurrency unit, mint certificate, settlement receipt, and optional index signal.

In a rollback workflow, an original record is found to contain an incorrect service category, date, identity link, domain link, value amount, or settlement status. An authorized actor creates a correction record. The system keeps the original record, signs the correction, links both records by hash, updates final status, and records the audit trail.

In a BIGX or BIGindex workflow, a verified service receipt is aggregated with identity, domain, time, and asset records. BIGX assigns a clearing or registration state. BIGindex computes or updates a reference score for the identity, domain, service, industry, or time-value record.

### 19. Technical Improvements and Examiner-Resilient Advantages

The system improves identity systems by generating behavior-economic identity records linked to domains, services, time, receipts, and assets rather than merely authenticating login sessions.

The system improves receipt systems by automatically generating verifiable, signed, privacy-preserving, and recoverable records without requiring the user to download an application or manually perform verification.

The system improves domain systems by converting domain names into loadable, policy-bound, indexable, and clearable economic nodes using signed endpoint records and domain routing rather than treating a domain as a passive web address.

The system improves token and value-generation systems by using proof-gated and policy-gated behavior-to-value processing rather than high-energy proof-of-work mining.

The system improves distributed auditability by replacing hidden deletion with rollback and clawback records that preserve original evidence and generate correction evidence.

The system improves anti-replay control by binding behavior objects, time windows, endpoint records, nonce or counter states, policy versions, and evidence commitments before minting or clearing outputs are generated.

The system improves productization of intellectual property by mapping foundational logic to product modules, product modules to patent-protective groups, and patent-protective groups to service workflows and receipt evidence.

The system improves capital, licensing, and due-diligence readiness by generating verified service records, DomainYLD metrics, BIGX records, settlement records, and BIGindex scores from actual product use.

### 20. Non-Limiting Nature

The embodiments described herein are non-limiting examples. A module may be implemented in software, hardware, firmware, a secure element, a trusted execution environment, a server, a mobile device, an IoT device, a web application, a domain registry, a wallet, a blockchain, a database, a cloud service, or a semiconductor chip.

A domain may be a conventional DNS domain, subdomain, rooted domain, YueName, namespace identifier, URI, DID, ledger address, or other resolvable identifier. A value unit may be a token, credit, receipt, index signal, certificate, service record, clearing record, accounting entry, settlement message, or internal unit. The scope is defined by the claims.

### 21. Additional Embodiments

### 21.1 Medical and Health Service Receipts

In embodiments involving medical and health service receipts, the system may receive one or more behavior objects, time-windowed events, domain nodes, identity anchors, proof signals, and policy containers. The BEI Logic Code Engine may classify the record, execute proof and policy gates, request any hardware-assisted signature or secure timestamp, and forward a signed receipt to wallet, clearing, callback, and index endpoints. The BEMINT core may generate a BEI Currency value, TimeCurrency value, DomainYLD signal, service score, or index-ready reference value according to the applicable policy container.

The medical and health embodiment may produce a user-visible record such as a verified page or certificate while hiding complex cryptographic, policy, and audit operations in the background. A public view may show a verified status and masked data; a private view may show extended data to authorized parties; an administrator or auditor view may show the full BEIFR, BEISign, callback, rollback, and index trail.

### 21.2 Education and Learning Time Records

In embodiments involving education and learning time records, the system may receive learning events, class attendance events, mentoring sessions, proof sources, institution identifiers, student or teacher identity anchors, and time windows. The proof and policy gates may confirm source authority, time validity, anti-replay state, and privacy constraints before the BEMINT core generates a time receipt, service value signal, or index-ready reference value.

The education embodiment may support family records, school records, continuing education, professional certification, and learning-service markets. Generated receipts may be routed to BEIWALLET, ATMS, clearing, audit, callback, and index endpoints under the applicable signed policy container.

### 21.3 Environmental and Green Behavior Records

In embodiments involving environmental or green behavior records, the system may receive sensor evidence, service evidence, human confirmation, device attestation, domain-node activity, and policy containers defining eligible environmental categories. Proof and policy gates may validate source authorization, anti-fraud status, rate limits, jurisdiction routing, and audit conditions before generating environmental contribution receipts, behavioral energy units, or index-ready green signals.

Such records may support household, company, regional, national, or industry-level reporting, Domain YLD scoring, TimeCurrency generation, BEI Currency generation, or BIGindex publication. Original evidence may be masked or committed while public outputs show verified status and aggregate contribution metrics.

### 21.4 Financial, Collateral, and Settlement Records

In embodiments involving financial, collateral, and settlement records, the system may link identity anchors, domain nodes, proof records, treasury state, collateral references, payment references, policy containers, reserve rules, and settlement routes. The clearing layer may generate registration records, settlement receipts, reconciliation records, and index feedback without requiring that the system itself operate as a regulated exchange unless a licensed deployment so provides.

A policy container may route different transactions to internal ledger records, stablecoin references, fiat payment instructions, CBDC references, partner settlement networks, or exchange-readiness modules. A rollback or clawback record may be generated when an authorized correction event, fraud event, or dispute-resolution event occurs.

### 21.5 Domain, Namespace, and Digital Parcel Records

In embodiments involving domain, namespace, and digital parcel records, a domain, subdomain, rooted domain, YueName, or namespace identifier may serve as a digital parcel, identity root, service terminal, receipt endpoint, asset container, minting node, wallet endpoint, clearing node, or index node. The system may publish or resolve signed endpoint records and policy containers for each node.

A domain may produce Domain Logic Value when it is bound to ownership or control data, a BEI identity, a service category, a certificate, a receipt endpoint, an industry classification, a human-need classification, a regulatory profile, a DomainYLD metric, a BIGX record, or a BIGindex score.

### 22. Support for Asset Packaging, Licensing, and Transfer

The disclosed architecture is suitable for packaging as an intellectual-property asset because the technical spine connects identity, domain routing, proof and policy gates, minting, receipts, callback, rollback, clearing, settlement, and index feedback. The same protected spine can be licensed by field of use, product module, jurisdiction, industry node, or hardware implementation.

Licensing fields may include identity, wallet, DID, domain registry, namespace, minting, currency, receipts, verification, clearing, exchange, settlement, index analytics, rollback compliance, hardware security modules, semiconductor implementations, IndustryPacks, NeedPacks, and diligence data rooms.

A transaction-ready package may include the patent application, claim chart, drawing map, product screenshots, API schemas, signed endpoint record examples, policy-container examples, receipt examples, rollback examples, clearing records, index outputs, and licensing schedules. This supports transfer, exclusive or non-exclusive licensing, certification, white-label deployment, or asset-backed diligence.

### 23. Claim-Support Summary

| Claim area | Specification support summary |
|---|---|
| System spine | Identity, domain routing, signed endpoints, |
| | proof/policy gates, BEI logic code, |
| | BEMINT/BEPU, signature/receipt, |
| | callback/rollback, clearing/index. |
| Domain routing | Rooted domains, YueName, namespace |
| | identifiers, signed endpoint records, policy |
| | windows, routing roles, endpoint verification. |
| Behavior and | Behavior objects, life-time events, time |
| TimeCurrency | windows, proof sources, policy containers, |
| | mint certificates, TimeCurrency receipts. |
| Audit and | BEIFR, BEISign, correction records, reversal |
| rollback | records, rollback hash, final status, preserved |
| | original record. |
| Method and | Receiving, binding, loading, resolving, |
| CRM claims | verifying, generating code, converting, |
| | signing, callback, rollback, clearing, indexing. |

### 24. Conclusion

The disclosed BEI×24HWS soft-hard core chip ecosystem provides a technical architecture for converting domain-routed identity, behavior, service, resource, and time records into verified economic records. The architecture is concrete at the data-object, cryptographic, routing, policy, minting, receipt, audit, clearing, settlement, and index layers. The embodiments are illustrative, and the scope is defined by the claims.

### 25. Additional Implementation Details for Written-Description and Enablement Support

The following implementation details are non-limiting and are provided to further describe how the disclosed BEI soft-hard core chip ecosystem may be implemented using concrete data structures, protocol messages, gate states, endpoint records, proof references, policy containers, receipt objects, rollback records, clearing records, and index outputs. The details organize the previously described layers without requiring any particular vendor, blockchain, database, cloud provider, device, or regulated exchange deployment.

A person of ordinary skill in distributed computing, identity management, cryptographic verification, ledger engineering, secure hardware, payment routing, or audit systems can implement the described functions using conventional programming languages, databases, key-management systems, API gateways, smart-contract platforms, message queues, and secure elements once the disclosed BEI data objects, state transitions, and routing rules are provided. The novelty lies in the particular combination and technical interaction of domain routing, identity anchoring, proof and policy gating, behavioral minting, receipts, callback, rollback, clearing, and index feedback.

### 26. Behavior Input Layer Implementation

The behavior input layer may expose REST endpoints, graph endpoints, mobile SDK functions, webhooks, event-stream subscriptions, device drivers, or message-queue topics. Each input route may require a source identifier, event class, time reference, domain node reference, evidence commitment, policy-version hint, and digital signature. The layer may reject events missing mandatory fields before any minting or index update can occur.

Input events may originate from mobile applications, web applications, IoT devices, wearables, point-of-sale terminals, identity terminals, healthcare terminals, education platforms, domain registries, service providers, wallets, or third-party systems. The system may normalize these inputs into behavior objects or life-time event objects using canonical field names and schema versions.

The layer may maintain replay-prevention memory for recently seen event identifiers, nonces, counters, or evidence commitments. When a duplicate input is detected, the system may mark the event as duplicate, stale, disputed, or rate-limited and may generate an audit event rather than deleting the incoming message.

The behavior input layer may operate at the edge or in the cloud. In edge embodiments, a secure element or trusted execution environment signs a local capture record before transmission. In cloud embodiments, a server validates an institutional or application signature and records the result in a tamper-evident audit log.

### 27. BEI Identity Anchor Layer Implementation

The BEI identity anchor layer may generate or update an identity profile from an account identifier, DID, wallet address, phone number, email address, domain node, credential, service record, provider attestation, or cryptographic key. The identity profile may include public identifiers, private identifiers, credential references, domain relationships, wallet endpoints, and permission states.

The layer may support privacy-preserving identity binding by storing sensitive identity fields in encrypted databases while storing commitments or hashes in endpoint records or tamper-evident structures. Public verification pages may display masked values while authorized views may access extended data according to policy.

An identity anchor may be associated with more than one domain node, device node, family node, organization node, region node, or industry node. A delegation record may specify whether a node is owner-controlled, provider-controlled, family-controlled, institution-controlled, or device-controlled.

Revocation, recovery, and key rotation may be handled as state transitions. A revoked key does not necessarily delete the prior record; instead, a revocation status, replacement key, validity window, and audit marker are published so that prior receipts remain verifiable while new actions use updated keys.

### 28. Domain Loading and Routing Substrate Implementation

The domain loading and routing substrate may receive a domain name, subdomain, rooted domain, YueName, URI, DID, namespace identifier, or ledger address and convert it into a functional economic node. The node may be assigned a node identifier, node class, parent namespace, policy profile, endpoint set, and routing priority.

The substrate may implement hierarchical lookup. A request may first resolve a root namespace, then a country or region node, then an industry or sector node, then an organization or family node, and finally a personal, device, or time node. Each stage may return a signed endpoint record, policy reference, or delegation marker.

The substrate may maintain node-status fields such as available, reserved, premium, approval-only, blocked, suspended, revoked, delegated, expired, or migrated. A controlled node may route to an application workflow, certificate workflow, manual review queue, or alternative namespace recommendation.

A domain loading record may include the node string, canonical representation, owner or controller reference, identity anchor, category, jurisdiction, industry, human-need classification, endpoint set, policy version, validity window, signature, and audit hash.

### 29. Signed Endpoint Record Implementation

A signed endpoint record may include a protocol role, endpoint address, public key, key commitment, certificate reference, DID reference, ledger anchor, policy-version identifier, validity window, revocation status, priority value, proof requirement, clearing route, and index publication rule.

The record may be signed by a domain controller, system controller, identity anchor key, policy authority key, or threshold group. Signature verification may occur before an endpoint is used for minting, callback, clearing, audit, or index publication. Invalid or expired endpoint records may cause the system to deny execution or route to a recovery endpoint.

Endpoint roles may include identity, proof, policy, minting, receipt, callback, wallet, clearing, exchange readiness, settlement, reconciliation, audit, compliance, governance, and index. A node may publish multiple endpoints for redundancy, failover, jurisdiction-specific routing, or field-of-use separation.

Endpoint records may be stored in DNS records, DID documents, ledger states, database tables, signed JSON objects, secure registry records, or combinations thereof. The disclosure is not limited to one storage mechanism so long as integrity, versioning, and routing semantics are preserved.

### 30. Proof Gate Implementation

The proof gate may evaluate whether an event source is authorized, whether an event signature is valid, whether a time reference is within an allowed validity window, whether a nonce or counter has been consumed, whether the evidence commitment matches the submitted data, and whether proof-source reputation satisfies the applicable policy container.

Proof gate output may include pass, fail, pending, degraded, quarantined, duplicate, expired, revoked, insufficient, or manual-review states. The output may be represented in the BEI logic code state vector and may control whether the BEMINT core can generate a value output.

The proof gate may accept multiple proof forms including provider attestation, device attestation, threshold signature, multi-signature approval, verifiable credential, zero-knowledge proof reference, trusted timestamp, ledger commitment, append-only log entry, secure-element signature, or external oracle data.

When proof is incomplete, the system may generate a non-minting receipt or pending receipt, thereby preserving the event trail while preventing unsupported value generation. This preserves auditability without allowing double counting or unverified minting.

### 31. Policy Gate Implementation

The policy gate may retrieve a signed policy container associated with a domain node, identity anchor, jurisdiction, industry, service category, time window, product module, or source type. The gate may validate the policy signature, version, effective date, expiration date, and revocation status before applying rules.

Policy parameters may include authorized sources, eligible event categories, weighting coefficients, mint caps, rate limits, transfer limits, privacy constraints, audit permissions, rollback boundaries, clearing requirements, index publication rules, jurisdiction routing, and manual-review triggers.

A policy decision may produce a policy state such as authorized, unauthorized, capped, rate-limited, suspended, restricted, field-of-use limited, jurisdiction-limited, privacy-limited, settlement-limited, or audit-required. The state may be logged and embedded in the receipt or mint certificate.

Policy updates may be deterministic by assigning effective time windows to versions. Events occurring under a prior policy may remain evaluated under that policy unless a correction, rollback, or regulatory rule requires later treatment. This improves auditability and prevents ambiguous retroactive changes.

### 32. BEI Logic Code Engine Implementation

The BEI logic code engine may assemble state fields from the identity anchor layer, behavior input layer, time module, proof gate, policy gate, risk module, minting module, clearing module, and index module. The state vector may be binary, numeric, alphanumeric, JSON, CBOR, protocol-buffer, database-row, or smart-contract-state encoded.

A logic code may include fields for identity state, behavior class, time-window state, proof grade, policy state, mint eligibility, currency type, receipt state, callback state, rollback state, clearing state, settlement state, index state, and risk state. The code may be updated at each gate transition.

Gate execution may be sequential, parallel, event-driven, or pipeline-based. For example, identity and endpoint verification may execute before proof and policy gates; minting may execute only after proof and policy pass; clearing may execute after receipt generation; index updates may execute after clearing or after a configured settlement-finality event.

Logic code outputs may be stored in receipts, mint certificates, clearing records, audit logs, and index records. The code provides a compact technical representation of why a record was accepted, rejected, corrected, cleared, or indexed.

### 33. BEMINT Core and Mint Transition Implementation

The BEMINT core may perform a minting transition only when the behavior object or life-time event is bound to an identity anchor, domain node, proof state, policy state, and time window. The transition may be atomic so that value output, receipt, policy version, evidence commitment, and identity binding are committed together.

The BEMINT core may compute value outputs using configured weights. Inputs may include behavior class, time duration, proof grade, policy coefficient, risk coefficient, domain coefficient, source reputation, service category, and index coefficient. The actual coefficients may be defined by a signed policy container rather than hard-coded.

Outputs may include BEI Currency, TimeCurrency, behavioral energy units, internal credits, mint certificates, settlement receipts, Domain YLD signals, service-value records, or index-ready records. A deployment may choose one output form or multiple output forms depending on field of use and regulatory authorization.

The mint transition may be denied if replay-prevention state indicates duplication, if the policy is expired, if the proof grade is insufficient, if a cap is reached, if the risk state is frozen, or if the endpoint record is revoked. The denial may produce an audit receipt but no value unit.

### 34. Signature and Receipt Layer Implementation

The signature and receipt layer may generate a BEIFR foundational record containing original facts, then produce a BEISign signature over the record or over a canonical commitment to the record. The signature may include a signer identifier, provider identifier, domain node, timestamp, key identifier, policy version, and audit marker.

An AutoVerified receipt may be generated as a user-facing derivative of the foundational record. The receipt may include privacy-safe fields, a verification hash, a verification URL, QR code, masked contact fields, service type, provider identifier, domain node, and receipt status.

The layer may support multiple views of the same record. A public view may show verification status and masked data. A private view may show extended fields to the identity owner or provider. An auditor view may show proof, policy, callback, rollback, clearing, and index trail fields according to permissions.

Receipts may be stored as database records, signed JSON objects, PDF certificates, verifiable credentials, wallet objects, ledger commitments, or hybrid records. The receipt format may be adapted to different product modules while preserving verification hash and audit semantics.

### 35. Callback Synchronization Implementation

The BEICallback module may transmit state updates to authorized endpoints identified by signed endpoint records. Callback events may include receipt-created, proof-passed, policy-passed, mint-issued, wallet-updated, clearing-submitted, settlement-completed, index-updated, correction-created, rollback-completed, or risk-frozen.

Callbacks may be delivered by webhook, REST API, graph API, message queue, email, SMS, push notification, ledger event, signed endpoint message, or partner-system adapter. A callback may include a signature, event identifier, original record reference, status code, policy version, retry counter, and delivery timestamp.

If callback delivery fails, the module may queue retries, mark an endpoint as unavailable, route to a secondary endpoint, or notify an operator. Failed callbacks may not invalidate the underlying receipt; instead, the audit trail records delivery attempts and final state.

Callbacks allow BEI records to synchronize with wallets, ATMS dashboards, BIGX clearing records, BIGindex computations, DomainYLD reports, partner systems, and compliance systems without requiring a single monolithic database.

### 36. Rollback and Clawback Implementation

The rollback or clawback module may generate a correction record or reversal record when an original record contains an error, when a fraud condition is detected, when a policy boundary is exceeded, when a dispute resolution rule applies, or when an authorized actor issues a correction under the applicable policy container.

The module preserves the original record and links it to the correction or reversal record. Fields may include original record identifier, correction identifier, reason code, authorized actor, timestamp, rollback hash, replacement data, affected value unit, settlement impact, final status, and audit signature.

Rollback boundaries may be defined by policy. A rollback may reverse a value output, freeze a record, reassign a value, mark a record as disputed, adjust an index state, or require manual review. The module may avoid generating new value beyond caps and may preserve both original and corrected states.

A rollback record may be routed to wallet endpoints, clearing endpoints, settlement endpoints, audit endpoints, compliance endpoints, and index endpoints so that downstream systems reflect the correction without erasing the historical record.

### 37. Clearing and Settlement Implementation

The clearing layer may receive receipts, mint certificates, value units, domain records, authorization rights, service rights, and asset records. It may assign a clearing status such as submitted, accepted, rejected, pending, netted, settled, reconciled, disputed, reversed, or indexed.

A settlement layer may generate internal settlement records, external settlement instructions, payment-route references, exchange-readiness records, reconciliation records, or clearinghouse receipts. The layer may be configured for internal ledger settlement, permissioned ledger settlement, cross-chain settlement, fiat payment instruction, stablecoin reference, or partner network settlement.

The clearing layer may compute net obligations across identities, domains, wallets, service providers, family nodes, industry nodes, or regional nodes. Netting may be periodic, event-driven, policy-defined, or manual-review controlled.

The system may operate as a clearing and registration framework without acting as a securities exchange. If a deployment performs regulated exchange functions, the endpoint record, policy container, and compliance profile may route the transaction to a licensed or authorized module.

### 38. Index Feedback Implementation

The BIGindex or BEIINDEX module may compute personal, family, organization, company, domain yield, service, time-value, industry, regional, national, or behavioral-economic indices. Inputs may include verified receipts, mint certificates, clearing records, settlement states, rollback records, source reputation, policy version, and time windows.

An index output may be a score, signal, rank, trend, alert, report, dashboard field, API value, or published commitment. The index may be private, semi-private, public, aggregate, anonymized, or permissioned according to policy.

Index feedback may affect future policy decisions, service tiers, domain yield reports, mint limits, proof requirements, risk states, and due-diligence reports. Thus, the system creates a technical feedback loop that is not merely descriptive but influences future routing, gating, minting, clearing, and index publication.

Index computations may preserve auditability by referencing input records and policy versions. If an input is corrected or rolled back, the index module may recompute affected outputs or generate correction markers.

### 39. Privacy and Selective Disclosure Implementation

The system may separate public, private, provider, auditor, and regulator views of the same foundational record. Sensitive identity fields may be encrypted, masked, tokenized, hashed, committed, or stored off-chain while public receipts display only verification status and privacy-safe fields.

Selective disclosure may be implemented through access tokens, role-based access control, attribute-based access control, verifiable credentials, zero-knowledge proof references, policy-defined auditor keys, or secure enclave queries. A policy container may specify which fields are visible to each role.

Privacy constraints may apply at input, receipt generation, callback delivery, clearing, settlement, rollback, and index publication. The system may prevent a callback endpoint from receiving fields beyond its authorized role.

A privacy-preserving receipt may still be verifiable because the verification hash or evidence commitment can be recomputed or checked without disclosing the underlying personal data to the public verifier.

### 40. Anti-Replay, Anti-Fraud, and Risk Control Implementation

Anti-replay controls may include event identifiers, nonces, counters, time windows, evidence commitments, source signatures, endpoint validity windows, policy versions, and consumed-state registries. A mint transition may be blocked when any replay-prevention condition fails.

Anti-fraud controls may evaluate behavior density, source reputation, device consistency, geographic consistency, timing anomalies, abnormal mint frequency, signature failures, endpoint changes, policy conflicts, and rollback history. The result may update a risk field in the BEI logic code.

Risk actions may include deny, downgrade, quarantine, rate limit, manual review, freeze, suspend, revoke endpoint, require stronger proof, require multi-signature approval, initiate rollback, or restrict clearing. Each risk action may be logged as an audit event.

Risk control may be implemented by deterministic rules, machine-learning signals, anomaly detection, policy bundles, human review, or combinations thereof. The disclosure is not limited to a particular AI model and may operate with rule-based controls when appropriate.

### 41. Hardware-Assisted Security Implementation

A hardware-assisted implementation may use a secure element, trusted execution environment, SIM, eSIM, NFC device, IoT sensor, wearable, mobile device, point-of-sale terminal, identity card, payment terminal, router, edge gateway, or hardware wallet. Such hardware may protect keys, sign local events, timestamp records, verify device integrity, or accelerate proof operations.

The soft-hard interface may transmit logic codes, behavior objects, policy parameters, proof requests, receipt objects, callback messages, rollback records, wallet updates, clearing outputs, settlement records, and index updates between hardware and software modules.

A secure element may store private keys and release only signatures or attestations. A trusted execution environment may validate a sensor record or local application state before signing. A point-of-sale terminal may capture service evidence and transmit a signed receipt event.

Hardware assistance is optional. A deployment may begin as software-defined and later add secure elements, TEEs, card devices, mobile devices, or semiconductor BEPU implementations without changing the core protocol semantics.

### 42. Semiconductor-Implementable BEPU Implementation

A semiconductor-implementable behavioral economic processing unit may include instruction decoders for BEI logic codes, state registers for identity, behavior, time, proof, policy, minting, clearing, index, and risk states, secure key storage, receipt hash accelerators, proof-gate accelerators, policy memory, minting transition logic, callback queues, rollback registers, and clearing interfaces.

The BEPU may be implemented as a dedicated chip, subsystem, secure co-processor, FPGA configuration, ASIC design, microcontroller firmware, secure module, or system-on-chip component. The BEPU need not mint legal tender; it executes behavioral-economic state transitions and outputs records, certificates, receipts, or signals according to policy.

The BEPU may interoperate with cloud modules, mobile applications, domain registries, wallets, clearinghouses, and index modules. The BEPU may receive signed inputs and output signed state transitions, allowing hardware-rooted trust without centralizing all data.

A semiconductor licensing pathway may license instruction sets, endpoint protocols, receipt formats, policy containers, BEI logic code handling, rollback registers, or secure key management to foundries, device makers, secure-element providers, financial terminal makers, and system integrators.

### 43. External System Integration

External systems may connect through REST APIs, graph APIs, SDKs, webhooks, message queues, logic-code interfaces, domain endpoint records, policy-container interfaces, wallet connectors, identity providers, payment systems, healthcare systems, education systems, IoT platforms, governmental platforms, or exchange adapters.

An external system may be granted a source role, verifier role, provider role, clearing role, audit role, index role, or callback role. The signed endpoint record and policy container may define the allowed role, endpoint, proof requirements, rate limits, and effective windows.

A partner system may submit behavior records, receive callback updates, request verification, participate in clearing, receive settlement instructions, or publish index outputs. Each action may require signature verification and policy-state validation.

Integration through endpoint records reduces hard-coded bilateral integrations. A new service node can be discovered and governed using the same routing and verification semantics as existing nodes.

### 44. Domain YLD and Domain Logic Value Implementation

DomainYLD may represent a domain yield or domain output metric. Inputs may include verified receipts, service records, identity relationships, TimeCurrency records, BEI Currency records, rooted-domain certificates, clearing states, callback performance, rollback history, index scores, and industry classification.

Domain Logic Value may arise when a domain is bound to ownership or control data, identity anchors, service categories, endpoint roles, certificates, policy containers, receipt endpoints, audit records, clearing records, and index outputs. A domain thereby becomes a functional economic node rather than a passive address.

A Domain YLD report may include domain node, identity anchor, service category, proof grade, policy profile, receipt count, verified time units, settlement status, rollback count, risk status, and index trend. The report may be signed and linked to a verification page.

DomainYLD values may support product pricing, premium node control, licensing, due diligence, membership tiers, or index publication. The values are technical outputs of verified records and policy-bound computations.

### 45. Rooted Domain Certificate Implementation

A Rooted Domain Certificate may include a domain node, owner or controller reference, identity anchor, category, industry, jurisdiction, policy version, endpoint record hash, signature, verification URL, issuance time, expiration time, and audit metadata.

The certificate workflow may check whether the domain node is available, reserved, premium, approval-only, blocked, or regulated. If approval is required, the workflow may route to proof collection, manual review, payment, credential verification, or alternative node selection.

The certificate may be displayed publicly with privacy-safe fields while maintaining private ownership or control evidence in an authorized view. The certificate may also be routed to wallets, BIGX records, Domain YLD reports, or index modules.

A certificate may be renewed, transferred, corrected, revoked, or delegated. Each state change may create a signed record linked to the prior state rather than deleting historical certificate evidence.

### 46. Time Namespace Implementation

A time namespace may include hour, day, week, month, year, lifetime, generation, service period, professional session, care period, education period, health period, environmental contribution period, or nested windows. Each time namespace may resolve to endpoint records and policy containers.

A time namespace may define mint caps, proof requirements, sampling rules, audit cycles, settlement cycles, rate limits, index publication periods, or rollback windows. For example, a short window may enforce strict nonce consumption, while a longer window may support reconciliation and aggregate index publication.

TimeCurrency generation may require that a service duration be linked to a provider identity, receiver identity, proof source, domain node, policy container, and value rule. The resulting time receipt may include start time, end time, duration, time window identifier, policy version, and verification hash.

Nested time windows allow a single life-time event to be evaluated at multiple aggregation levels without double minting. The system may distinguish raw event records, mint-eligible time units, cleared time units, and index-only aggregate signals.

### 47. Wallet and Asset Record Implementation

A wallet endpoint may receive BEI Currency units, TimeCurrency units, receipts, mint certificates, rooted-domain certificates, DomainYLD reports, authorization rights, service rights, or index records. The wallet may display balances, receipts, pending records, corrections, frozen states, and clearing states.

Wallet records may be non-transferable, conditionally transferable, transferable, redeemable, index-only, receipt-only, or settlement-limited according to policy. The policy state may be carried in the record and enforced during transfer or redemption requests.

An asset record may represent a domain asset, patent asset, service record, identity record, time record, certificate, data asset, or industry node. The asset record may be associated with licensing terms, field-of-use tags, receipt evidence, and index signals.

Wallet integration allows product modules to become user-visible while preserving underlying proof, policy, audit, and clearing controls. A wallet display is not required for the invention, but it is a practical deployment path.

### 48. Patent Asset Package Implementation

A patent asset package may map claims, specification sections, drawings, product modules, API endpoints, domain assets, receipt examples, clearing records, index outputs, and licensing fields into a data-room structure. The package may include module tags, field-of-use tags, jurisdiction tags, product-readiness tags, and diligence notes.

The package may show how the system spine covers identity, domain routing, proof gates, policy gates, logic code, BEMINT, receipts, callback, rollback, clearing, settlement, and index feedback. This mapping supports transfer, licensing, certification, white-label deployment, and investor diligence.

A claim-to-product map may identify Rooted Domain Certificate, BEI-ID, Auto Verify Receipt, BEISign, BEICallback, recoverable BEI record, TimeCurrency receipt, BEI Currency receipt, BIGX genesis record, and BIGindex score as exemplary protected product modules.

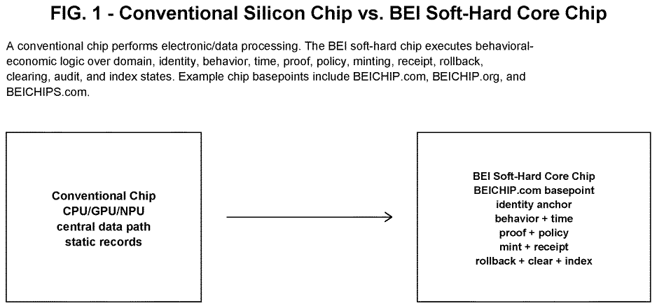

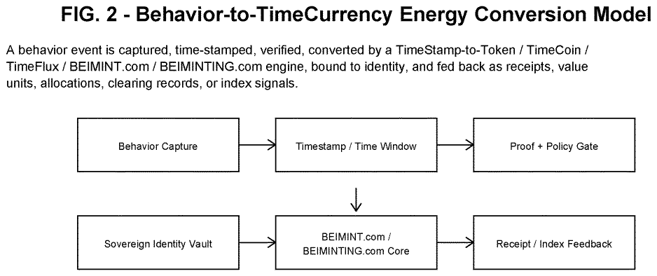

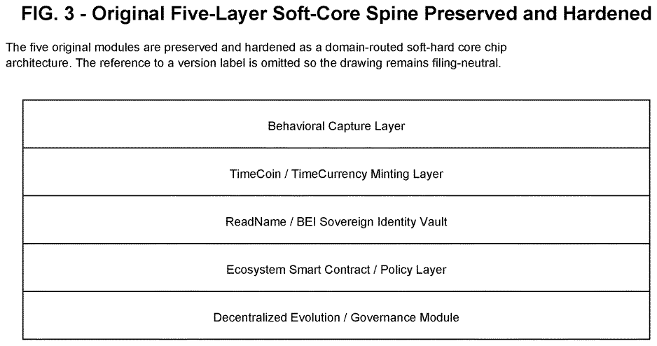

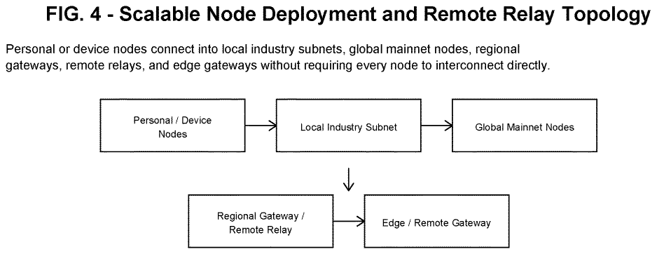

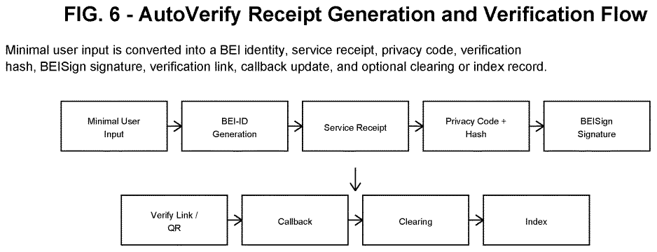

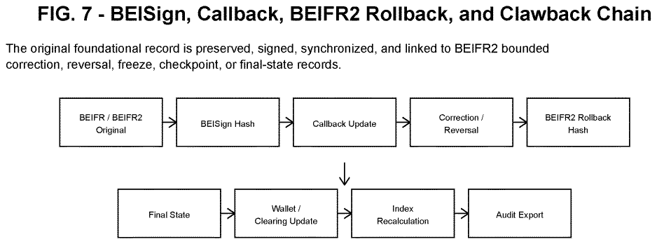

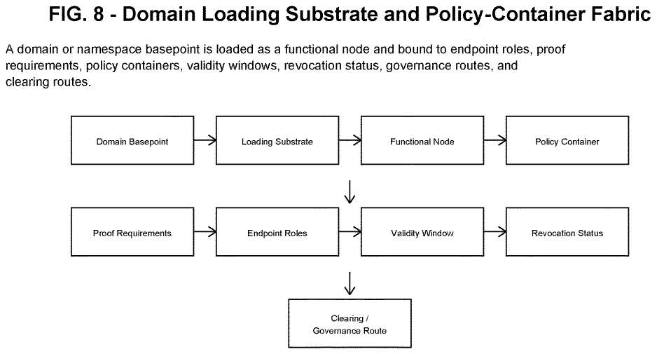

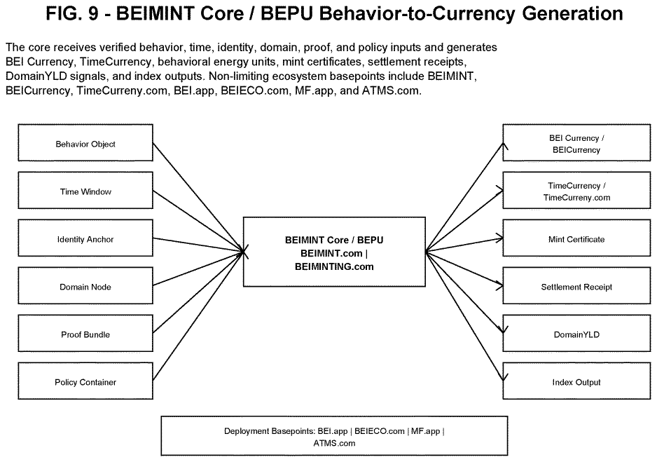

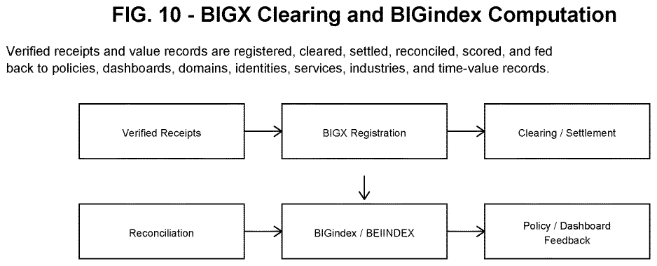

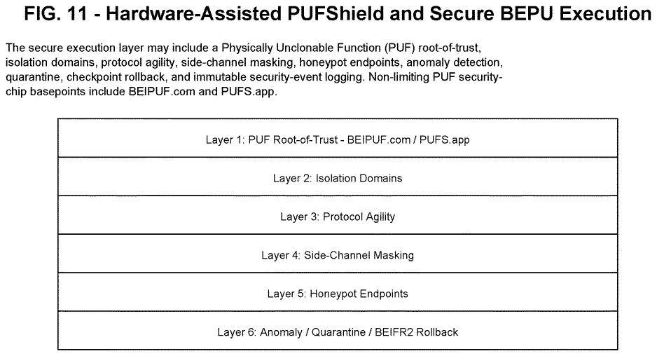

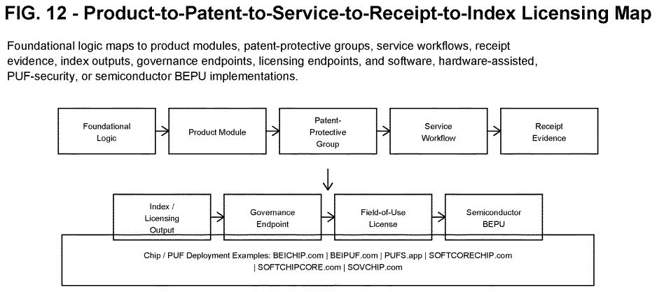

The data-room package may include a drawing map linking FIGS. 1-12 to product workflows. Such mapping does not limit the claims but helps third parties understand field-of-use licensing opportunities.

### 49. Medical, Education, Finance, and Public-Service Industry Packs

IndustryPacks may adapt the same BEI spine to healthcare, telehealth, vehicle safety, wearable safety, education, logistics, finance, commerce, public service, environmental reporting, family office, and energy systems. Each IndustryPack may define domain nodes, proof sources, policy containers, receipt formats, clearing rules, and index outputs.

A medical IndustryPack may process appointment records, screening records, care periods, provider confirmations, and health-domain certificates under privacy constraints. An education IndustryPack may process attendance, tutoring, credentialing, and learning-time records. A finance IndustryPack may process collateral references, payment records, reserve constraints, clearing messages, and settlement receipts.

A public-service IndustryPack may process service contributions, emergency response, community participation, environmental contribution, or government-service receipts. Each IndustryPack may share common BEI logic while using sector-specific proof requirements and policy parameters.

Because each IndustryPack uses the same identity, domain, proof, policy, receipt, callback, rollback, clearing, and index spine, the architecture avoids fragmenting into isolated vertical applications.

### 50. Data Storage and Tamper-Evident Structures

The system may store detailed records in relational databases, graph databases, object stores, encrypted vaults, secure elements, distributed ledgers, permissioned ledgers, append-only logs, WORM storage, Merkle structures, or hybrid systems. The storage mechanism may be selected according to privacy, cost, speed, and regulatory requirements.

A public ledger need not store sensitive personal data. The system may store commitments, hashes, signatures, policy versions, endpoint hashes, and receipt identifiers in tamper-evident structures while retaining detailed data in controlled storage.

Record retention may be governed by policy containers. A policy may specify retention period, deletion eligibility, masking rule, correction rule, audit access, export format, and index publication limit. Deletion of private data may coexist with preservation of non-sensitive commitments when legally required.

Storage records may be synchronized across nodes using callback messages, settlement messages, or reconciliation jobs. Conflicts may be resolved by policy version, timestamp, signature priority, clearing state, or manual review.

### 51. Interoperability and Message Format Implementation

Protocol messages may be represented as JSON, XML, CBOR, protocol buffers, ISO-style messages, smart-contract events, database events, message-queue payloads, or signed documents. Each message may include schema version, sender, recipient, domain node, endpoint role, policy version, validity window, signature, and audit hash.

Interoperability mappings may convert internal BEI records to external payment, clearing, identity, healthcare, education, or compliance message formats. A mapping may preserve receipt identifiers, policy states, evidence commitments, settlement states, and audit references.

Adapters may be field-of-use specific. For example, a financial adapter may generate payment or settlement instructions; a healthcare adapter may generate a privacy-limited service verification; an education adapter may generate a learning-time certificate; a domain adapter may publish endpoint records.

The routing substrate and endpoint record layer allow new adapters to be added without changing the core behavior-to-value, receipt, callback, rollback, clearing, and index logic.

### 52. Testing, Audit, and Compliance Export Implementation

The system may generate test events, simulation records, sandbox receipts, policy test cases, endpoint verification reports, replay-prevention tests, rollback drills, clearing simulations, and index recalculation reports. Such testing may occur before deployment or during ongoing compliance monitoring.

Audit exports may include foundational record identifiers, receipt hashes, policy versions, endpoint records, proof states, logic-code states, callback states, rollback records, clearing states, settlement states, and index references. Sensitive fields may be masked according to policy.

A compliance export may be generated for an auditor, regulator, partner institution, licensing counterparty, or internal governance body. The export may be signed and may include a verification hash so that it can be checked independently.

Testing and audit modules strengthen the technical implementation by making the system observable, reproducible, and correctable. These modules also support prosecution, licensing, and diligence by showing practical use of the disclosed architecture.

### 53. Deployment Modes

A single-tenant deployment may run for one organization or domain portfolio. A multi-tenant deployment may host many individuals, families, organizations, industries, or regions. A federated deployment may allow independently operated nodes to interoperate through signed endpoint records and shared policy semantics.

A deployment may begin with receipt generation only, then add TimeCurrency, BEI Currency, clearing, index, or hardware-assisted functions in stages. Each stage may preserve the same data spine so that early product evidence can support later licensing or diligence.

A local deployment may process records within a jurisdiction, while a cross-border deployment may route through jurisdiction-specific policy containers and clearing endpoints. A regulated deployment may integrate licensed financial, healthcare, or identity providers.

Deployment modes may be configured through policy and endpoint records rather than requiring separate inventions for each vertical. This modularity enables broad but technically bounded protection.

### 54. Example Claim-Covered Transaction Sequence

In one exemplary sequence, a user performs a service event through a domain-addressed application. The application creates a behavior object containing an event identifier, identity anchor, domain node, service type, timestamp, evidence commitment, nonce, and source signature.

The domain loading substrate resolves the domain node to a signed endpoint record identifying proof, policy, minting, receipt, callback, clearing, and index endpoints. The proof gate validates the source signature, evidence commitment, time window, nonce, and replay state. The policy gate validates authorized sources, mint caps, rate limits, privacy rules, and clearing requirements.

The BEI logic code engine generates a state vector showing that identity is anchored, behavior is captured, time window is valid, proof grade satisfies policy, minting is permitted, clearing is pending, index update is pending, and risk is not frozen. The BEMINT core then generates a TimeCurrency receipt and mint certificate.

The signature and receipt layer signs the foundational record and creates a privacy-safe verification link. The callback layer sends updates to the wallet and clearing endpoint. The clearing layer registers and settles the record. The index layer computes or updates a score. If later correction is required, the rollback module preserves the original record and links a correction record.

### 55. Alternative Embodiments and Equivalents

The system is not limited to blockchain, public ledgers, smart contracts, DNS, DID documents, or any particular cloud architecture. Equivalent tamper-evident structures, signed registries, append-only logs, secure databases, or permissioned ledgers may be used.

The system is not limited to a token legal classification. A value output may be a receipt, certificate, internal unit, point, credit, accounting entry, settlement instruction, service right, index signal, or other record. Legal treatment may depend on deployment, field of use, and jurisdiction.

The system is not limited to one namespace. A domain, subdomain, rooted domain, YueName, URI, DID, account identifier, ledger address, or other resolvable identifier may act as the functional basepoint when it resolves endpoint records and policy controls.

The order of operations may vary. Certain gates may be executed before or after endpoint routing, and certain receipts may be generated before clearing. The essential architecture is the technical linkage of identity anchoring, domain routing, proof and policy gating, value generation, receipts, callback, rollback, clearing, settlement, and index feedback.

### 56. Filing-Strategy Support and No-New-Matter Discipline

For a substitute specification in the existing application, the disclosed subject matter should be used to clarify, organize, and technically support originally disclosed concepts such as behavioral capture, timestamp-to-token conversion, sovereign identity vaulting, ecosystem smart-contract allocation, decentralized evolution, audit resilience, domain-node routing, receipts, clearing, and index feedback.

For a continuation-in-part strategy, broader integrations involving additional BEI, ATMS, DomainPI, BEIMINT, BEISign, rollback, clearing, settlement, and index families may be coordinated through the Application Data Sheet and cross-reference section. The official benefit claim should be limited to applications properly identified in the ADS.

The present specification avoids relying on pure marketing language by recasting value claims as technical modules, data structures, state transitions, signatures, proof gates, policy gates, endpoint records, receipts, rollback records, clearing records, and index outputs.

The claims should remain focused on concrete system components, computer-implemented method steps, and non-transitory computer-readable medium instructions. No multiple dependent claim is used in the accompanying replacement claim set.

### 57. Final Non-Limiting Statement

The foregoing detailed implementation sections provide written-description, enablement, and technical-architecture support for the disclosed BEI soft-hard core chip ecosystem. The embodiments may be combined in whole or in part, and a feature described in connection with one embodiment may be used with another embodiment unless expressly inconsistent. The scope of protection is defined by the claims and their lawful equivalents.

### 58. Identity Recovery and Delegation Controls

In certain embodiments, identity recovery and delegation controls may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address recovery keys, delegated family nodes, institutional providers, and domain controllers while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 59. Evidence Commitment and Hash Canonicalization

In certain embodiments, evidence commitment and hash canonicalization may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address canonical serialization, hash commitments, evidence bundles, and verification pages while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 60. Source Reputation and Provider Trust Scoring

In certain embodiments, source reputation and provider trust scoring may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address authorized providers, proof-source reputation, audit history, and risk-weighted gates while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 61. Field-of-Use Licensing Controls

In certain embodiments, field-of-use licensing controls may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address license scopes, product modules, jurisdiction constraints, and endpoint roles while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 62. Multi-Node Federation and Governance

In certain embodiments, multi-node federation and governance may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address federated nodes, policy publication, threshold signatures, and governance receipts while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 63. Receipt Lifecycle State Machine

In certain embodiments, receipt lifecycle state machine may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address draft, signed, verified, cleared, settled, corrected, indexed, and archived states while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 64. Mint Certificate Lifecycle State Machine

In certain embodiments, mint certificate lifecycle state machine may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address eligible, generated, wallet-routed, clearing-pending, settled, frozen, reversed, and expired states while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 65. Dispute Resolution and Exception Handling

In certain embodiments, dispute resolution and exception handling may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address dispute flags, reason codes, evidence review, rollback boundaries, and final status records while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 66. Domain Registry Synchronization

In certain embodiments, domain registry synchronization may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address rooted-domain certificates, endpoint refresh, revocation, migration, and renewal events while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 67. Index Recalculation After Correction

In certain embodiments, index recalculation after correction may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address input dependency tracking, rollback propagation, and corrected index publication while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 68. Sandbox and Staged Deployment

In certain embodiments, sandbox and staged deployment may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address test nodes, simulated minting, non-production receipts, and controlled activation while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 69. Security Boundary and Key Management

In certain embodiments, security boundary and key management may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address key generation, rotation, revocation, secure modules, and endpoint trust while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 70. Audit Trail Export Format

In certain embodiments, audit trail export format may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address record references, policy versions, signatures, endpoint hashes, and clearing states while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 71. Scalable Population-Level Routing

In certain embodiments, scalable population-level routing may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address regional gateways, sector nodes, personal nodes, device nodes, and time nodes while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 72. Licensing-Ready Evidence Generation

In certain embodiments, licensing-ready evidence generation may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address service evidence, product evidence, receipt evidence, and data-room outputs while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 73. Regulated and Non-Regulated Deployment Separation

In certain embodiments, regulated and non-regulated deployment separation may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address internal credits, receipts, settlement references, and licensed exchange routes while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 74. Hardware Manufacturer Integration

In certain embodiments, hardware manufacturer integration may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address foundry licensing, terminal devices, secure elements, and BEPU instruction handling while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 75. Cross-Portfolio Coordination

In certain embodiments, cross-portfolio coordination may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address related BEI, ATMS, DomainPI, BEIMINT, security, clearing, and index support while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 76. Examiner-Focused Technical Character

In certain embodiments, examiner-focused technical character may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address machine-readable states, gates, signed records, protocol routing, and audit corrections while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 77. Commercialization Without Claim Limitation

In certain embodiments, commercialization without claim limitation may be implemented as part of the same BEI soft-hard core chip architecture using concrete data structures, signed endpoint records, policy containers, proof-gate states, BEI logic code fields, receipt objects, callback messages, rollback records, clearing states, and index outputs. The implementation may address SaaS, API, certificate, wallet, clearing, index, and hardware licensing examples while preserving the domain-routed behavior-to-currency and TimeCurrency generation spine described above.

A corresponding record may include a unique identifier, identity-anchor reference, domain-node reference, event class, time-window identifier, endpoint-record hash, policy-version identifier, source signature, evidence commitment, privacy field, risk state, clearing state, index state, and audit hash. The record may be stored in a database, append-only log, permissioned ledger, distributed ledger, secure element, or hybrid storage system according to the applicable policy container.

The module may interact with other modules through a signed message. A message may specify the sender role, recipient role, endpoint address, validity window, nonce or counter, requested action, prior-state reference, new-state proposal, and signature. The receiving module may verify the endpoint record, policy version, signature, and replay-prevention state before accepting the message.

If a validation condition fails, the module may deny the action, quarantine the record, request stronger proof, route to manual review, freeze a generated unit, generate a correction record, or transmit a callback event to an authorized endpoint. The failure state may be preserved in the audit chain so that later review can determine why a record was not minted, cleared, settled, indexed, transferred, or displayed.

These implementation details do not limit the system to one programming language, ledger type, database, cloud provider, identity provider, hardware provider, or regulatory model. They show that the invention is a practical computer-implemented architecture using specific machine-readable objects and technical state transitions rather than an abstract business idea.

### 78. V5 Claim-Hardening and Original-Matter Preservation Layer

This V5 integration preserves the originally filed soft-core chip subject matter while expressing the invention through concrete machine components, data structures, state machines, signed endpoint records, proof gates, policy gates, mint certificates, rollback records, clearing records, and index outputs. The originally disclosed five-column soft-core spine-Behavioral Capture Layer, TimeStamp-to-Token or TimeCoin Engine, Sovereign Identity Vault or ReadName Vault, Ecosystem Smart Contract Layer, and Decentralized Evolution Module—is retained as the continuity spine and is further implemented by the BEI soft-hard core chip architecture described herein.

The Behavioral Capture Layer is implemented as a behavior-event envelope generator that receives mobile, IoT, wearable, web-hook, provider, institutional, environmental, and service events. Each envelope may carry an identity anchor, domain node, timestamp, time-window identifier, evidence commitment, source signature, nonce, counter, proof reference, privacy-safe display field, policy version, and anti-replay state.

The TimeStamp-to-Token Engine, also referred to as a TimeCoin Engine, may be implemented by or may interoperate with the BEMINT core or BEPU. The engine verifies a cryptographic time proof, validity window, policy-container version, and replay-prevention state before converting a verified event into a BEI Currency unit, TimeCurrency unit, behavioral energy unit, mint certificate, settlement receipt, DomainYLD signal, or index-ready record.

The Sovereign Identity Vault or ReadName Vault is preserved as an identity-anchor vault that manages BEI-ID, DID, wallet, account identifier, domain basepoint, cryptographic key pair, sharded storage, multi-signature authorization, recovery state, revocation state, and delegated control records for individuals, families, organizations, devices, industry nodes, regions, nations, and institutions.

The Ecosystem Smart Contract Layer is preserved as a policy-container and smart-contract execution layer. It may implement configurable 365-industry, 999-human-need, and 1,600-subsystem-interface taxonomies, cross-contract delegation, resource allocation, yield distribution, compliance caps, rate limits, human-need mapping, industry mapping, field-of-use licensing rules, settlement routing rules, and index publication rules.

The Decentralized Evolution Module is preserved as a topology, governance, and policy-adaptation state machine. It may update endpoint priority, routing path, node status, node health, gateway failover, proof requirement, policy version, minting cap, risk state, clearing route, index feedback rule, or manual-review queue based on behavior throughput, endpoint health, callback failure, oracle data, consensus state, risk signals, or clearing exceptions.

### 79. Examiner-Focused Technical Improvement Summary

| Issue | Technical answer in the present disclosure |
|---|---|
| Section 101 practical | The claims recite a concrete computer |
| application | architecture that performs domain endpoint |
| | resolution, identity anchoring, proof and |
| | policy gate state-machine verification, atomic |
| | mint-and-bind transition, signed receipt |
| | generation, callback synchronization, rollback |
| | preservation, clearing, settlement, and index |
| | feedback. |
| Section 102 novelty | The combination of a domain-loaded |
| | economic node, signed endpoint record, |
| | identity-anchored behavior-event envelope, |
| | time-window anti-replay state, policy-gated |
| | BEMINT/BEPU transition, BEIFR/BEISign |
| | receipt, correction-preserving rollback, and |
| | clearing/index feedback is not a conventional |
| | website, wallet, reward system, or blockchain |
| | transfer. |
| Section 103 | Even if isolated pieces such as domains, |
| non-obviousness | wallets, receipts, smart contracts, or |
| | timestamps are known, the claimed |
| | interoperability spine links them into a |
| | stateful behavior-to-value processing chip |
| | architecture with anti-replay minting, policy- |
| | bounded issuance, audit-preserving |
| | correction, and asset-package licensing |
| | outputs. |
| Section 112 support | The specification defines behavior objects, |
| | life-time events, signed endpoint records, |
| | policy containers, time proofs, logic-code |
| | state vectors, mint certificates, receipts, |
| | rollback records, clearing records, index |
| | outputs, hardware interfaces, and |
| | semiconductor BEPU implementation details. |

### 80. Original Claim-to-V5 Preservation Summary

Original claim 1 is preserved by the V5 independent system claim through the behavior input layer, Behavioral Capture Layer, TimeStamp-to-Token/TimeCoin Engine, Sovereign Identity Vault/ReadName Vault, Ecosystem Smart Contract/Policy Layer, and Decentralized Evolution Module, now tied to signed behavior-event envelopes, proof and policy gate state machines, mint certificates, rollback records, clearing records, and index outputs.

Original claims concerning mobile, IoT, and web-hook capture are preserved through behavior input and envelope-generation embodiments. Original claims concerning Proof-of-Authority, programmable temporal redeemability, sharded storage, multi-signature key management, cross-contract delegation, yield distribution, demand modules, AI-optimized pricing, node self-growth, environmental sensors, dual-channel attestation, oracle interfaces, ReadVault confirmation, sovereign mapping, AI governance, cross-chain NFT resource circulation, per-second behavioral-energy accounting, anomaly circuit breakers, and global timescale integration are preserved in the dependent claims and implementation sections.

The present filing set also preserves the later integrated BEI-Nation, BEIMINT, BEISign, Auto Verify, BEICallback, BEIFR2 rollback, Domain YLD, BIGX/BEIGX/BEISX, BIGindex/BEIINDEX, soft-hard interface, secure hardware, semiconductor BEPU, IndustryPack, NeedPack, and asset-package licensing content, but organizes it into examiner-readable modules and transaction-ready licensing groups.

### 81. Transaction, Transfer, and Licensing Support without Limiting Claims

The disclosed architecture supports field-of-use licensing, module licensing, white-label deployment, certification, hardware manufacturer integration, domain registry integration, wallet integration, clearinghouse integration, index data subscription, and asset-backed diligence. A license may be scoped by product module, domain node, endpoint role, jurisdiction, industry, policy-container version, hardware implementation, security profile, clearing route, receipt schema, callback right, rollback right, index publication right, or BEPU instruction-set implementation.

A transaction-ready asset package may include the patent filing set, claim chart, original-to-new preservation matrix, drawing map, endpoint-record examples, policy-container examples, BEIFR/BEISign receipt examples, rollback examples, mint certificate examples, TimeCurrency examples, clearing records, index outputs, product screenshots, API schemas, domain inventory, licensing schedule, and field-of-use schedule. These asset-package materials are examples of implementation support and do not limit claim scope.

### 82. V6 Family-Integrated Hardening Layer from Related Soft-Chip Records

This V6 family-integrated layer further preserves and organizes related soft-chip subject matter that is consistent with the original Ser. No. 19/193,369 disclosure of a Behavioral Capture Layer, TimeStamp-to-Token or TimeCoin Engine, Sovereign Identity Vault or ReadName Vault, Ecosystem Smart Contract Layer, and Decentralized Evolution Module. The layer is expressed as technical implementation support for those originally disclosed modules and does not require unsupported performance claims, speculative physical effects, or purely promotional language.

In certain embodiments, the TimeStamp-to-Token Engine includes a TimeFlux weighting module. The TimeFlux module computes a policy-defined time weight from intervals between successive verified behavior events, service events, or life-time events. The time weight may be applied to a TimeCurrency unit, BEI Currency unit, behavioral energy unit, mint certificate, settlement receipt, DomainYLD signal, or index-ready record only after proof and policy gates validate authenticity, authorization, uniqueness, time-window validity, anti-replay state, proof-source status, and policy-container compliance.

In certain embodiments, a tamper-evident immutable-tape record, append-only log, ledger commitment, Merkle commitment, WORM record, secure registry record, or equivalent integrity-preserving structure stores or anchors an event identifier, identity-vault reference, domain-token or domain-node reference, TimeFlux weight, policy version, proof state, mint certificate reference, receipt hash, rollback reference, clearing state, index state, and audit hash.

In certain embodiments, a Global Licensing Gateway, field-of-use licensing endpoint, royalty-calculation reference, certification endpoint, or transaction-ready asset-package endpoint is represented as a signed endpoint record or policy-container role. The gateway may store license scope, product-module identifier, jurisdiction scope, industry scope, hardware implementation scope, royalty schedule reference, authorization state, receipt schema, clearing route, and verification hash without requiring the claimed system to perform a regulated exchange function.

In certain embodiments, a configurable taxonomy maps behavior objects or life-time events to industry categories, human-need categories, demand categories, resource categories, currency-reference categories, and subsystem-interface categories. The taxonomy may include a 365-industry classification, a 999-need classification, a 999-by-365 need-industry matrix, a 1,600-interface taxonomy, or a different configurable matrix selected by a policy container.

In certain embodiments, the BEI soft-hard core chip includes a hardware-assisted security layer that protects identity signing, proof verification, policy execution, minting transition, receipt generation, callback delivery, rollback processing, clearing, settlement, and index publication. The security layer may include a PUF-derived root-of-trust attestation value, isolation domains, protocol agility, side-channel masking, honeypot endpoint nodes, anomaly detection, quarantine, checkpoint rollback, live microkernel replacement, and immutable security-event logging.

### 83. Hardware-Assisted Root-of-Trust, PUFShield, and Isolation Domains

A root-of-trust module may bind a device, firmware state, key state, identity anchor, domain node, signing module, endpoint record, or BEPU execution state to a PUF-derived attestation value, secure-element key, trusted-execution attestation, SIM or eSIM identity, hardware wallet key, or other hardware-protected secret. The root-of-trust module may verify firmware integrity, endpoint validity, signing authority, and key continuity before a proof gate, policy gate, mint gate, clearing gate, or index gate is permitted to execute.

Isolation domains may segment identity, behavior, time, proof, policy, minting, receipt, callback, rollback, clearing, settlement, index, risk, and audit states. Inter-domain communication may require signed messages, authenticated bus transactions, endpoint-record verification, policy-version checks, replay-prevention checks, or key-continuity verification. A deployment may use software isolation, container isolation, process isolation, trusted-execution isolation, secure-element isolation, hardware bus isolation, or semiconductor security zones.

A PUFShield or equivalent noise-injection security circuit may include a PUF array, programmable electromagnetic or power-noise injection unit, timing randomizer, reconstruction-window controller, and authentication module. The circuit may vary response timing, power profile, electromagnetic profile, bus-visible profile, or reconstruction windows to reduce side-channel correlation during identity signing, proof generation, proof verification, TimeCurrency generation, mint-certificate generation, receipt signing, or rollback authorization.

A protocol-agility engine may rotate endpoint protocols, key schedules, instruction encodings, handshake parameters, bus timings, access sequences, callback formats, or routing paths according to a policy container, risk state, random seed, PUF-derived value, or security-event log. The engine may reduce replay, endpoint reuse, side-channel inference, stale-route attacks, and unauthorized minting requests.

### 84. Fractal Defense, Honeypot Endpoints, Anomaly Detection, and Quarantine

A fractal defense shield may be implemented as a layered security sub-system around proof gates, policy gates, signed endpoint records, minting transitions, receipt generation, clearing, and index publication. The shield may include a PUF root-of-trust layer, isolation-domain layer, protocol-agility layer, side-channel masking layer, honeypot endpoint layer, anomaly detection layer, quarantine layer, and rollback layer.

Honeypot endpoint nodes may emulate identity, proof, policy, minting, wallet, receipt, callback, clearing, settlement, audit, compliance, governance, exchange-readiness, or index endpoints. When an unauthorized request, replay attempt, malformed signature, suspicious endpoint change, excessive minting frequency, side-channel anomaly, or proof-source inconsistency is detected, the honeypot endpoint may divert the request to a forensic audit path while preserving evidence commitments and preventing value generation.

An anomaly detection engine may evaluate protocol features, power features, timing features, endpoint changes, callback failures, replay attempts, proof-source reputation, device consistency, behavior density, geographic consistency, mint-frequency deviations, rollback history, clearing exceptions, and index feedback. The anomaly detection engine may be rule-based, statistical, machine-learning based, neural-network based, or hybrid. Output states may include pass, fail, degraded, quarantined, frozen, rate-limited, manual-review, rollback-required, or endpoint-revoked.

A quarantine module may isolate compromised sub-kernels, endpoint routes, proof sources, wallets, identity anchors, domain nodes, callbacks, policy containers, or clearing paths. The module may freeze minting, deny settlement, require stronger proof, initiate rollback, update endpoint priority, generate a security-critical event log, or route a correction to clearing and index modules.

### 85. Decentralized Evolution, Self-Healing, Checkpoint Rollback, and Live Replacement

The Decentralized Evolution Module may monitor node health, endpoint health, gateway health, proof-source health, callback delivery, clearing status, settlement status, policy validity, risk state, index feedback, and replay-prevention state. The module may perform peer-list reconfiguration, endpoint rerouting, state resynchronization, gateway failover, node retirement, node activation, workload balancing, or policy-container update when a failure or attack condition is detected.

Checkpoint-based rollback may preserve a prior verified state, generate a correction or reversal record, link the correction to the original foundational record, update wallet, clearing, settlement, and index endpoints, and maintain an audit trail showing original state, correction state, and final state. Live microkernel replacement or service-kernel hot-swap may replace a compromised or failed execution component while preserving signed receipts, mint certificates, endpoint manifests, and policy-container references.

Remote relay and edge gateway embodiments may support geographically distributed, maritime, aviation, disaster-response, rural, orbital, remote, or space-related gateway nodes. Such embodiments may use conventional satellite, edge, mesh, or relay networks and do not require a particular interplanetary physical link to practice the claimed behavior-to-value processing architecture.

### 86. Green Flux, Thermoelectric Assistance, and Energy-Aware Policy Execution

In certain embodiments, a hardware-assisted edge module includes an auxiliary energy-recovery circuit. The circuit may harvest a temperature-differential signal, motion signal, light signal, sensor energy signal, or waste-heat signal and provide auxiliary power or energy-credit evidence to a secure signing, timestamping, sensor-attestation, proof, receipt, or edge-routing circuit.

A thermoelectric embodiment may include vertically aligned conductive pillars, an organic or polymer composite, a temperature-differential interface, a stabilization circuit, a supercapacitor, a voltage regulator, a micro-power recovery loop, or a power-gating controller. These components may support edge signing, secure timestamping, sensor attestation, or Green Flux evidence without requiring that value generation be based on physical energy alone.

A policy container may compute or reference a Green Flux, energy-credit, environmental contribution, sensor-attested resource, or sustainability score. The score may affect proof requirements, mint caps, TimeCurrency weighting, DomainYLD reporting, clearing readiness, or index publication. The system may distinguish between a technical energy-recovery signal, a policy-defined energy-credit record, and a regulated energy or financial product.

### 87. On-Chain Governance, REST/WASM Gateway, and Cross-Ledger Synchronization

An on-chain or off-chain governance interface may be exposed through REST, WebSocket, WASM, smart-contract, message-queue, graph, or signed-endpoint gateways. The governance interface may support proposal submission, voting, execution, policy publication, endpoint update, minting-cap update, proof-source approval, rollback authorization, clearing rule update, index publication rule update, and licensing rule update.

A multi-tier permission model may assign roles to owner, identity holder, provider, family node, organization, industry node, region, nation, institution, council, auditor, regulator, device, domain controller, or partner endpoint. A behavior-currency weighting mechanism may compute execution, voting, routing, or clearing weight according to verified TimeCurrency, BEI Currency, Green Flux, identity reputation, domain yield, source reputation, clearing status, or index feedback.

Cross-chain or cross-ledger bridging logic may synchronize external ledgers, permissioned ledgers, databases, clearinghouses, wallets, payment adapters, identity providers, domain registries, healthcare systems, education systems, finance systems, or compliance systems using signed endpoint records and policy-container rules. The bridging logic may produce non-minting audit receipts when proof or policy is incomplete.

### 88. Formal Filing Discipline and Claim-Boundary Preservation

The claims should remain directed to concrete system components, computer-implemented method steps, and non-transitory computer-readable medium instructions. Promotional statements, speculative performance metrics, absolute security terms, unlimited-compute language, and unsupported physical effects are not required for patentability and may be omitted from the claims while preserved separately in asset-package or research materials.

Numeric examples such as protocol-state counts, entropy sizes, timing windows, leakage reductions, energy-recovery percentages, throughput levels, node counts, detection accuracies, and relay latencies are non-limiting examples unless expressly recited in a claim. The technical contribution is the interoperating architecture of identity anchoring, domain endpoint resolution, proof/policy gates, anti-replay states, TimeStamp-to-Token or TimeFlux weighting, BEMINT/BEPU execution, signed receipts, callback, rollback, clearing, index, hardware security, and asset-package licensing support.

What is claimed is:

1. A distributed audit-resilient human sovereign soft-hard core chip system for domain-routed behavior-to-currency and TimeCurrency generation, comprising: a Behavioral Capture Layer configured to generate a signed behavior-event envelope for an identity-anchored behavior object or life-time event; a Sovereign Identity Vault, including a ReadName vault or equivalent identity-anchor vault, configured to bind the signed behavior-event envelope to a BEI identity anchor; a domain loading and routing substrate configured to load a domain name, subdomain, rooted domain, YueName, namespace identifier, or domain basepoint as a functional economic node; a signed endpoint record resolver configured to resolve the functional economic node to at least one identity endpoint, proof endpoint, policy endpoint, minting endpoint, receipt endpoint, callback endpoint, clearing endpoint, audit endpoint, compliance endpoint, governance endpoint, licensing endpoint, or index endpoint; a proof-gate and policy-gate state machine configured to verify authenticity, authorization, uniqueness, time-window validity, anti-replay state, proof-source status, and signed policy-container compliance; a TimeStamp-to-Token Engine, TimeCoin Engine, TimeFlux module, BEMINT core, or behavioral economic processing unit configured to execute an atomic mint-and-bind transition that converts the verified behavior object or life-time event into a BEI Currency unit, TimeCurrency unit, behavioral energy unit, mint certificate, settlement receipt, DomainYLD signal, or index-ready record; a signature and receipt layer configured to generate a BEIFR foundational record, BEISign signature, Auto Verified receipt, verification hash, verification link, or privacy-safe display field; a callback, rollback, and clawback audit layer configured to transmit authorized state updates and to preserve original records while generating correction or reversal records; a clearing and index feedback layer configured to register, clear, settle, reconcile, score, or index the generated record; and a hardware-assisted security layer configured to protect at least one of identity signing, proof verification, policy execution, minting transition, receipt generation, callback delivery, rollback processing, clearing, settlement, or index publication.

2. The system of claim 1, wherein the domain loading and routing substrate maps the domain name, subdomain, rooted domain, YueName, namespace identifier, or domain basepoint to at least one of an identity root, digital parcel, service terminal, receipt endpoint, asset container, minting node, wallet endpoint, clearing node, exchange-readiness node, index node, IndustryPack node, NeedPack node, certification endpoint, or field-of-use licensing node.

3. The system of claim 1, wherein the signed endpoint record resolver publishes or validates an endpoint record including a protocol role, endpoint address, public key, key commitment, certificate reference, policy-version identifier, validity window, revocation status, priority value, proof requirement, fallback route, clearing route, governance route, licensing route, audit route, or index publication rule.

4. The system of claim 1, wherein the TimeStamp-to-Token Engine, TimeCoin Engine, or TimeFlux module computes a policy-defined time weight from intervals between successive verified behavior events, service events, or life-time events and applies the time weight to a TimeCurrency unit, BEI Currency unit, mint certificate, settlement receipt, Domain YLD signal, or index-ready record after validating a cryptographic time proof, trusted timestamp, validity window, nonce, counter, consumed-state registry, policy-container version, and replay-prevention state.

5. The system of claim 1, wherein the Sovereign Identity Vault or ReadName vault manages at least one of a BEI-ID, DID, wallet address, account identifier, domain basepoint, cryptographic key pair, PUF-derived attestation value, sharded storage record, multi-signature authorization, threshold signature, biometric-interface reference, recovery state, revocation state, delegated-control record, or privacy-preserving identity commitment.

6. The system of claim 1, wherein an Ecosystem Smart Contract Layer or signed policy-container layer maps the signed behavior-event envelope to a configurable taxonomy comprising industry categories, human-need categories, demand categories, resource categories, currency-reference categories, and subsystem-interface categories, including a 365-industry, 999-need, 999-by-365, or 1,600-interface taxonomy, and controls at least one of cross-contract delegation, resource allocation, yield distribution, mint caps, rate limits, field-of-use licensing, royalty-reference metadata, settlement routing, or index publication.

7. The system of claim 1, wherein a Decentralized Evolution Module updates a node topology, endpoint priority, policy version, proof requirement, routing path, gateway failover state, minting cap, risk state, clearing route, index feedback rule, quarantine state, peer list, or manual-review queue based on behavior throughput, endpoint health, callback failure, oracle data, consensus state, anomaly score, risk signals, clearing exceptions, or index feedback.

8. The system of claim 1, wherein the hardware-assisted security layer comprises a root-of-trust module configured to bind a device, firmware state, key state, identity anchor, domain node, signing module, endpoint record, or behavioral economic processing unit execution state to a PUF-derived attestation value, secure-element key, trusted-execution attestation, SIM or eSIM identity, hardware wallet key, or hardware-protected secret.

9. The system of claim 1, wherein the hardware-assisted security layer further comprises at least one isolation domain, protocol-agility engine, side-channel masking unit, honeypot endpoint node, or anomaly detection engine configured to segment execution states, rotate endpoint protocols or key schedules, randomize power, timing, electromagnetic, or bus-observable leakage, emulate valid endpoints for forensic diversion, or quarantine compromised sub-kernels or endpoint routes.

10. The system of claim 1, wherein the callback, rollback, and clawback audit layer or the clearing and index feedback layer records a security-critical event, replay attempt, malformed signature, endpoint change, side-channel anomaly, minting-frequency deviation, correction record, reversal record, freeze state, checkpoint rollback, live microkernel replacement, settlement impact, final status, or index recalculation in a tamper-evident structure linked to the BEIFR foundational record, BEISign signature, mint certificate, settlement receipt, or verification hash.

11. A computer-implemented method executed by a distributed BEI soft-hard core chip system, comprising: receiving a behavior object or life-time event; generating a signed behavior-event envelope through a Behavioral Capture Layer; binding the signed behavior-event envelope to a BEI identity anchor through a Sovereign Identity Vault or ReadName vault; loading a domain name, subdomain, rooted domain, YueName, namespace identifier, or domain basepoint as a functional economic node; resolving a signed endpoint record associated with the functional economic node to identify an identity endpoint, proof endpoint, policy endpoint, minting endpoint, receipt endpoint, callback endpoint, clearing endpoint, audit endpoint, compliance endpoint, governance endpoint, licensing endpoint, or index endpoint; verifying authenticity, authorization, uniqueness, time-window validity, anti-replay state, proof-source status, and signed policy-container compliance through a proof-gate and policy-gate state machine; computing a policy-defined TimeFlux or TimeCurrency weight from at least one timestamp, time interval, time window, service duration, or nested time window; generating or executing a BEI logic code state vector representing identity state, behavior class, time-window state, proof grade, policy state, mint eligibility, clearing state, index state, and risk state; executing an atomic mint-and-bind transition that converts the verified behavior object or life-time event into a BEI Currency unit, TimeCurrency unit, behavioral energy unit, mint certificate, settlement receipt, DomainYLD signal, or index-ready record; generating a BEIFR foundational record, BEISign signature, AutoVerified receipt, verification hash, verification link, or privacy-safe display field; transmitting an authorized callback update; preserving an original record while generating a correction or reversal record when a rollback or clawback condition is satisfied; and registering, clearing, settling, reconciling, scoring, or indexing the generated record.

12. The method of claim 11, further comprising normalizing input from a mobile application, IoT device, wearable device, web-hook interface, provider terminal, institution system, environmental sensor, financial terminal, domain registry, hardware security module, secure element, trusted execution environment, or edge gateway into the signed behavior-event envelope.

13. The method of claim 11, further comprising storing detailed behavior or service data off-chain while anchoring a commitment to a tamper-evident data structure selected from a distributed ledger, permissioned ledger, append-only log, Merkle structure, WORM storage, secure registry, immutable-tape record, or equivalent integrity-preserving structure.

14. The method of claim 11, further comprising routing a generated receipt or mint certificate through a clearinghouse, exchange-readiness module, wallet endpoint, domain node, index module, partner callback endpoint, payment adapter, settlement adapter, field-of-use licensing endpoint, royalty-reference endpoint, governance endpoint, or audit export endpoint identified by the signed endpoint record.

15. The method of claim 11, further comprising detecting an anomaly associated with protocol features, power features, timing features, endpoint changes, callback failures, replay attempts, proof-source reputation, behavior density, minting-frequency deviation, rollback history, or clearing exception, and in response performing at least one of endpoint rerouting, peer-list reconfiguration, quarantine, checkpoint rollback, live microkernel replacement, mint freeze, clearing denial, index correction, or stronger-proof request.

16. The method of claim 11, further comprising publishing a public verification page displaying a verified status and privacy-safe display fields while masking, hashing, tokenizing, encrypting, or selectively disclosing sensitive identity or contact data according to the signed policy container.

17. A non-transitory computer-readable medium storing instructions that, when executed by one or more processors of a BEI soft-hard core chip system, cause the one or more processors to: generate signed behavior-event envelopes for identity-anchored behavior objects or life-time events; bind the signed behavior-event envelopes to BEI identity anchors through Sovereign Identity Vault or ReadName vault records; load domain names, subdomains, rooted domains, YueNames, namespace identifiers, or domain basepoints as functional economic nodes; resolve signed endpoint records to identify identity, proof, policy, minting, receipt, callback, clearing, audit, compliance, governance, licensing, or index endpoints; execute proof-gate and policy-gate state machines that verify authenticity, authorization, uniqueness, time-window validity, anti-replay state, proof-source status, and signed policy-container compliance; compute policy-defined TimeFlux or TimeCurrency weights; execute BEI logic code state vectors; operate a BEMINT core or behavioral economic processing unit to generate BEI Currency units, TimeCurrency units, behavioral energy units, mint certificates, settlement receipts, Domain YLD signals, or index-ready records; generate signed receipts and verification hashes; transmit authorized callback updates; preserve original records while generating rollback or clawback correction records; and register, clear, settle, reconcile, score, or index generated records.

18. The non-transitory computer-readable medium of claim 17, wherein the instructions further cause the one or more processors to interoperate with a hardware-assisted secure module selected from a trusted execution environment, secure element, SIM, eSIM, NFC device, IoT sensor, wearable terminal, point-of-sale terminal, identity terminal, hardware wallet, edge gateway, router device, financial terminal, PUF-based circuit, noise-injection circuit, thermoelectric auxiliary-power circuit, or secure key-management module.

19. The non-transitory computer-readable medium of claim 17, wherein the BEI soft-hard core chip system comprises a semiconductor-implementable behavioral economic processing unit including instruction decoders for BEI Logic Codes, secure key storage, root-of-trust attestation registers, isolation-domain interfaces, proof-gate accelerators, receipt-hash accelerators, policy-container memory, minting transition logic, protocol-agility state memory, side-channel masking controls, callback queues, rollback registers, clearing interfaces, anomaly-risk registers, and index-signal output logic.

20. The non-transitory computer-readable medium of claim 17, wherein the instructions further cause the one or more processors to generate a transaction-ready asset-package record including a claim-to-product mapping, product-module identifier, endpoint-manifest hash, policy-container version, receipt schema, rollback schema, clearing route, index-output reference, field-of-use license scope, jurisdiction scope, hardware implementation scope, governance endpoint, royalty-reference metadata, certification state, or verification hash.
